(19) United States
(12) Patent Application Publication
(10) Pub. No.: US 2014/0122200 A1
(43) Pub. Date: May 1, 2014

(54) MARKETING PROMOTION GENERATION, MANAGEMENT, AND DISTRIBUTION

(71) Applicant: Charles S. Granville, Laguna Hills, CA (US)

(72) Inventor: Charles S. Granville, Laguna Hills, CA (US)

(21) Appl. No.: 13/665,356

(22) Filed: Oct. 31, 2012

(51) Int. Cl. G06Q 30/02

(52) U.S. Cl. CPC G06Q 30/0212; G06Q 30/0276
USPC 705/14.14; 705/14.72

(57) ABSTRACT

This disclosure is drawn to methods, systems, devices and/or apparatus related to generating, managing, operational management, distributing, administering, and/or analyzing simple to extremely complex marketing promotion campaigns. Specifically, the disclosed methods, systems, devices and/or apparatus relate generating, managing, distributing, administering, and/or analyzing a variety of marketing promotion campaigns simultaneously (including sweepstakes, user-generated contests, instant win campaigns, coupons, group buying promotions, sales incentives, trivia games, loyalty programs, donation promotions, and the like) on simultaneous media channels the Internet, social networks, and/or mobile platforms. There are many types of promotions, which may be combined for use in a single marketing promotion campaign. Example systems may include a promotion builder engine, a user interface design engine, a user management component, a prize management component, a rules generation engine, an award selection and notification component, and/or an analytics component.

### CROSS-REFERENCE TO RELATED APPLICATIONS

This application claims the benefit of U.S. Provisional Application No. 61/605,179, titled “METHODS AND SYSTEMS FOR PROVIDING AND MANAGING MARKETING PROMOTION CAMPAIGNS,” filed on Feb. 29, 2012, the disclosure of which is incorporated herein by reference.

### BACKGROUND

Marketing promotions on the Internet (including via social networks) and mobile (including via cellular phones), print and other media are used by many companies and organizations as a means of marketing their products and/or services. One conventional component of marketing promotions is providing awards (or prizes) to promotion participants. Example promotions include sweepstakes, user-generated contests, instant win campaigns, coupons, group buying promotions, business to business (B2B) sale incentives, and nonprofit donation promotions.

Many marketing professionals believe digital and social media promotions are an important part of their marketing strategies. Some studies show that companies that run social media promotions on social networks have about twice the followers of those who do not run social media promotions. Some marketers report that it only takes 10 promotion “plays” or less to generate an opt-in by the consumer to a company's more general marketing promotion campaign. Typically, opt-in data is more accurate with promotions since consumers know they may need to be contacted to receive an award. Additionally, about 75% of consumers say they are more likely to purchase from a company after playing a promotion.

### SUMMARY OF THE DISCLOSURE

In a first aspect, systems for generating a promotion are provided. Example systems may include a promotion builder engine, a user interface design engine, a user management component, a rules generation engine, an award selection component, and/or an analytics/reporting component. An example promotion builder engine may receive information associated with the promotion from a promotion creator, and structure the promotion based on the information associated with the promotion and promotion file databases having predetermined promotion data. An example user interface design engine may generate a user interface for the promotion. An example user management component may manage users of the promotion. An example rules generation engine may generate the official promotion rules that need to be displayed and possibly filed and registered associated with the promotion. The rules may be based on the information association with the promotion and rules databases having predetermined contractual language data. An example award selection component may manage award(s) and select user(s) as winner(s) of an award. An example analytics component may analyze metrics of the promotion and may generate reports associated with the promotion.

In a second aspect, methods of generating a promotion are provided. Example methods may include receiving, via a computer network, information associated with a promotion from a promotion creator. Example methods may also include receiving, via the computer network, instructions associated with designing a user interface of the promotion from the promotion creator. Example methods may also include generating, via a computing device, a structure of the promotion based on the information associated with the promotion and promotion file databases having predetermined promotion data. Example methods may further include generating, via the computing device, rules associated with the promotion based on the information association with the promotion and rules databases having predetermined contractual language data. Example methods may further include distributing, via the computer network, the promotion and the rules to a marketing channel.

In a third aspect, computer-readable medium(s) may include instructions thereon configured to operate network accessible computing device(s). Such instructions may cause the network accessible computer device(s) to perform the steps of: receive, via a computer network, information associated with a promotion from a promotion creator; receive, via the computer network, instructions associated with designing a user interface of the promotion from the promotion creator; generate, via the computing device, a structure of the promotion based on the information associated with the promotion and promotion file databases having predetermined promotion data; generate, via the computing device, rules associated with the promotion based on the information association with the promotion and rules databases having predetermined contractual language data; and distribute, via the computer network, the promotion and the rules to a marketing channel. The promotions manager controls the users from across all media channels simultaneously and manages simultaneously their rules of play for any combination of promotion types. This level of complexity is unique and requires the collection and processing of substantial promotion information typically 50-100 data collection questions and data fields per promotion. The promotion manager performs many operational tasks such as winner selection, winner notification, prize management, alternative winner selection and notification, and legal rule generation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 depicts an example system for generating a promotion;

FIG. 2 depicts an example method of generating a promotion;

FIG. 3 depicts a computer-readable medium having instructions thereon, where the instructions operate a network accessible computing device to perform certain operations associated with promotion generation;

FIG. 4 depicts example screenshots illustrating aspects and examples of generating, managing, managing, and/or distributing an example promotion;

FIG. 5 depicts example screenshots illustrating aspects and example of generating, managing, managing, and/or distributing an example promotion;

FIG. 6 depicts example screenshots illustrating aspects and example of generating, managing, managing, and/or distributing an example promotion;

FIG. 7 depicts example screenshots illustrating aspects and example of generating, managing, managing, and/or distributing an example promotion;

FIG. 8 depicts example screenshots illustrating aspects and example of generating, managing, managing, and/or distributing an example promotion;

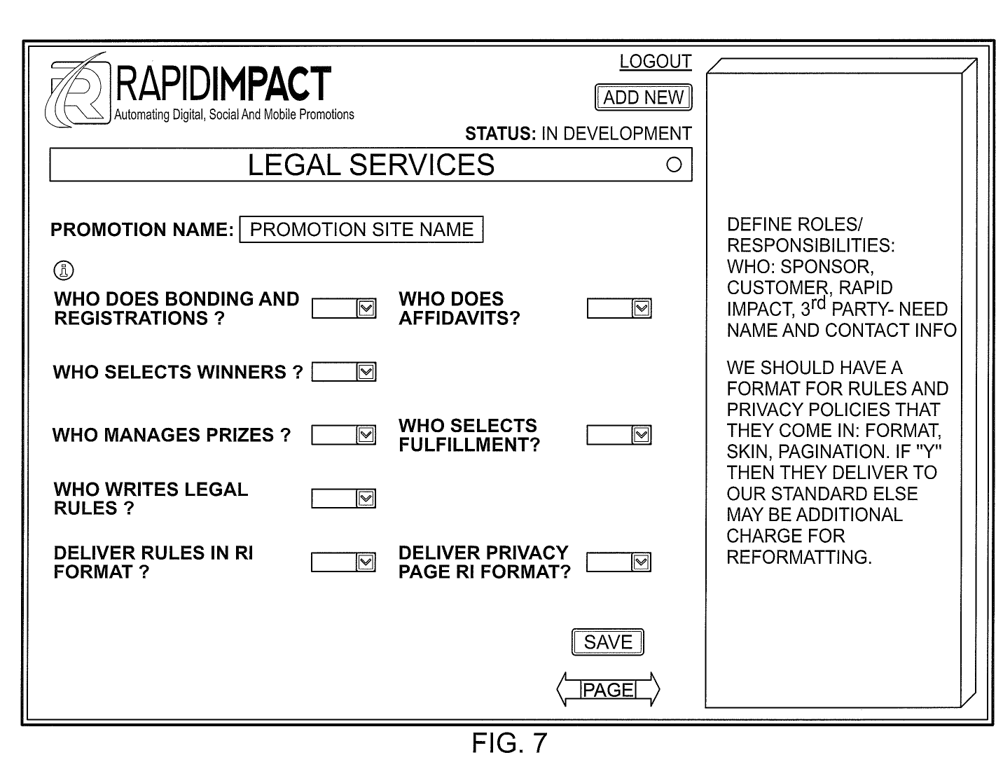

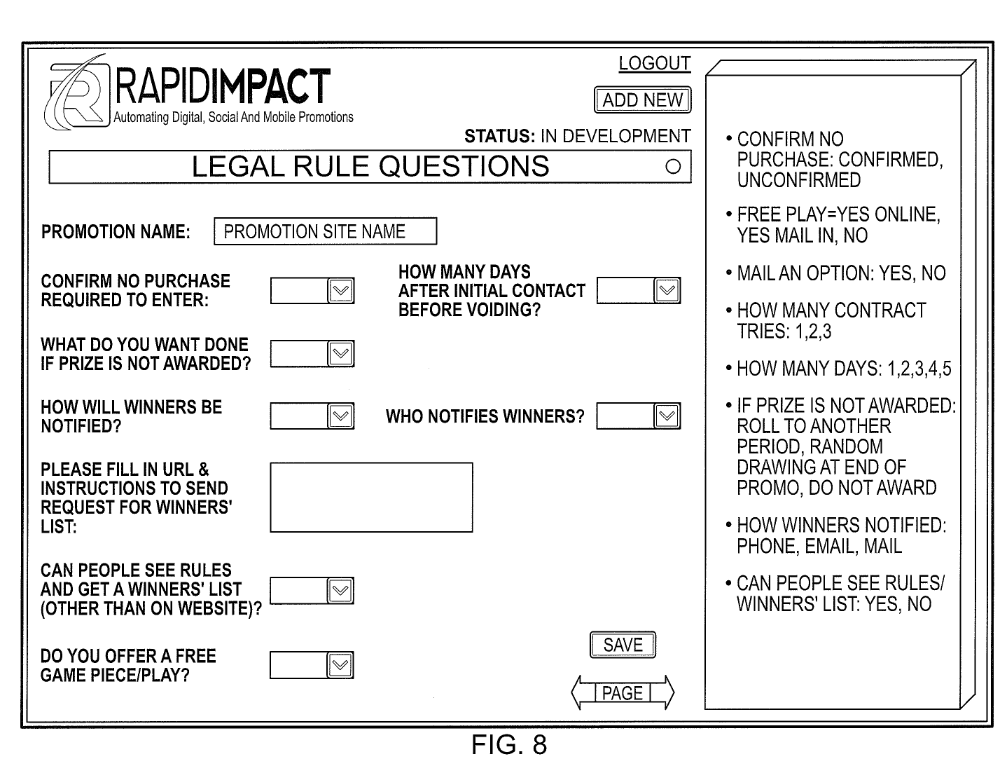

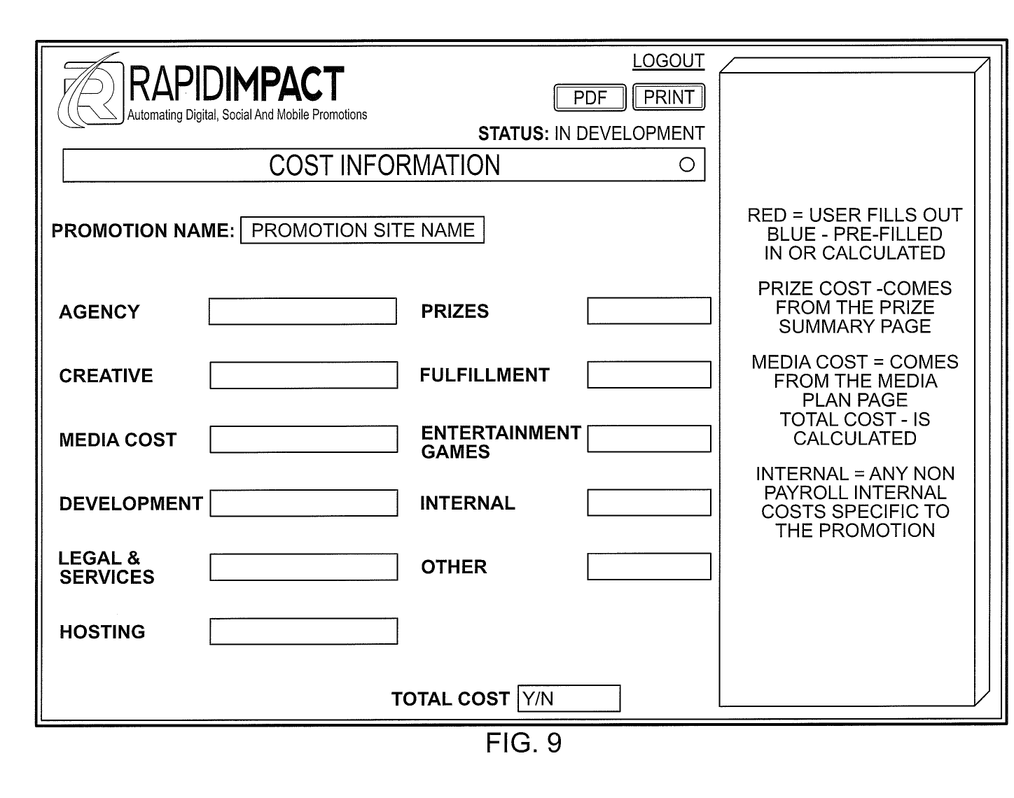

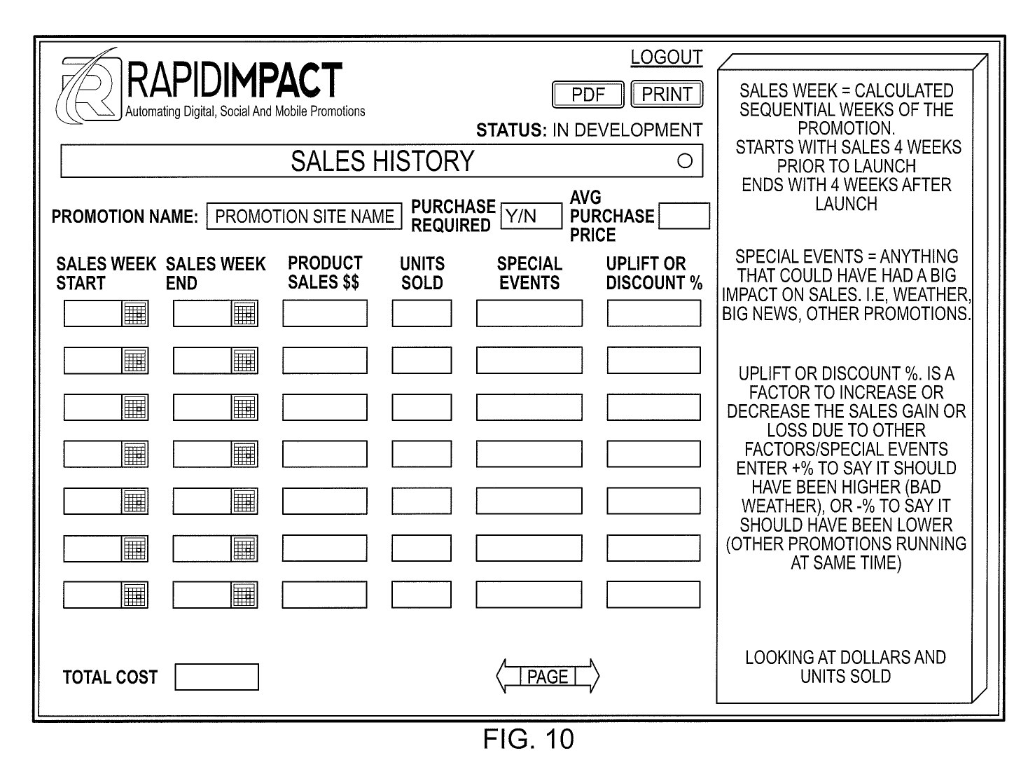

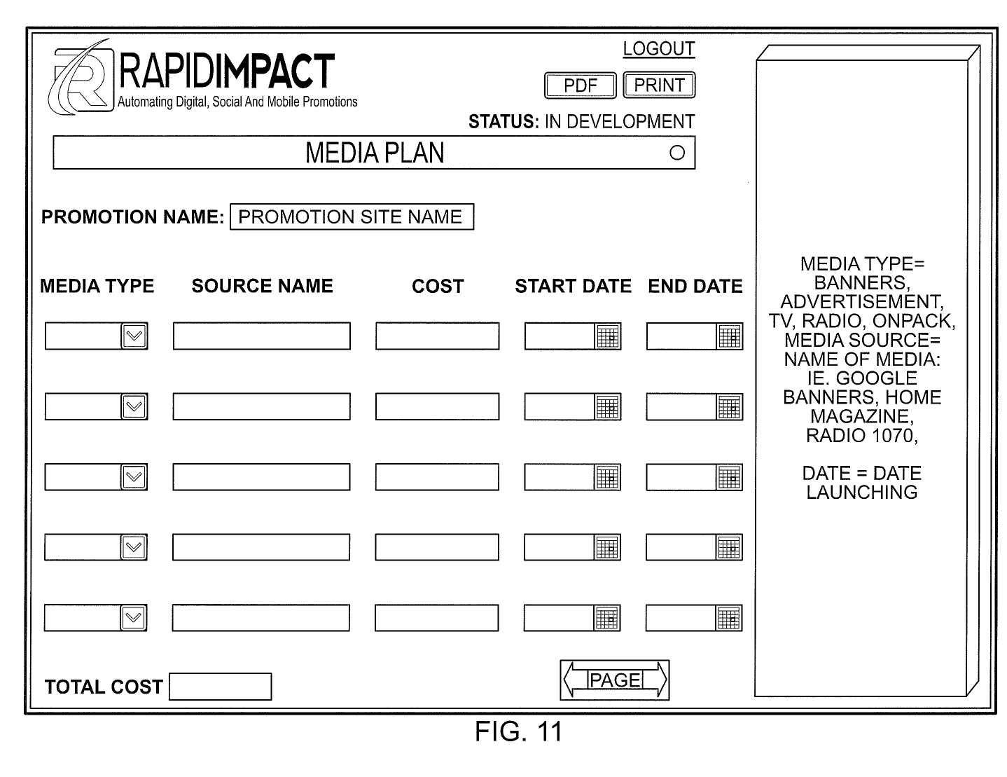

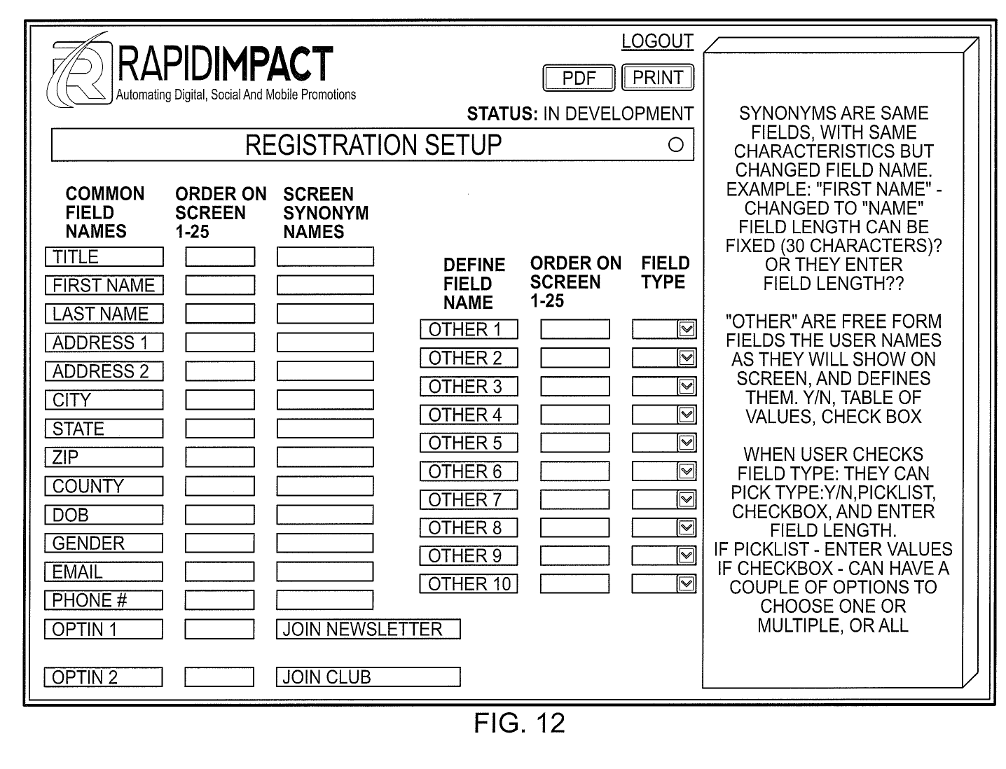

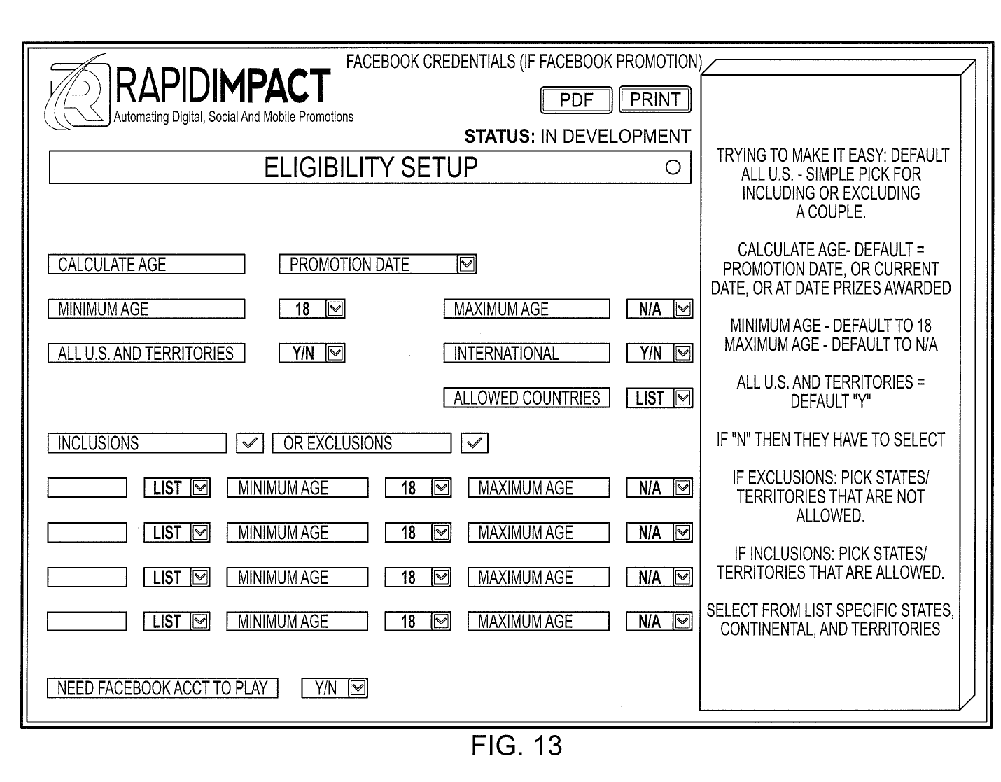

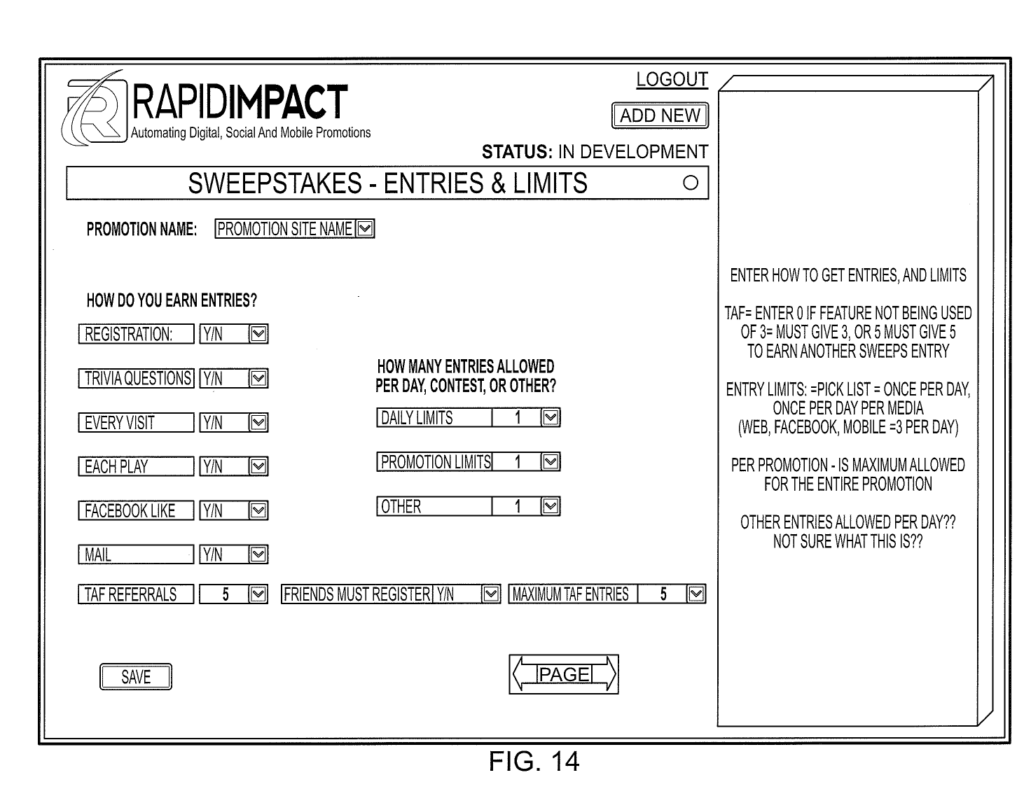

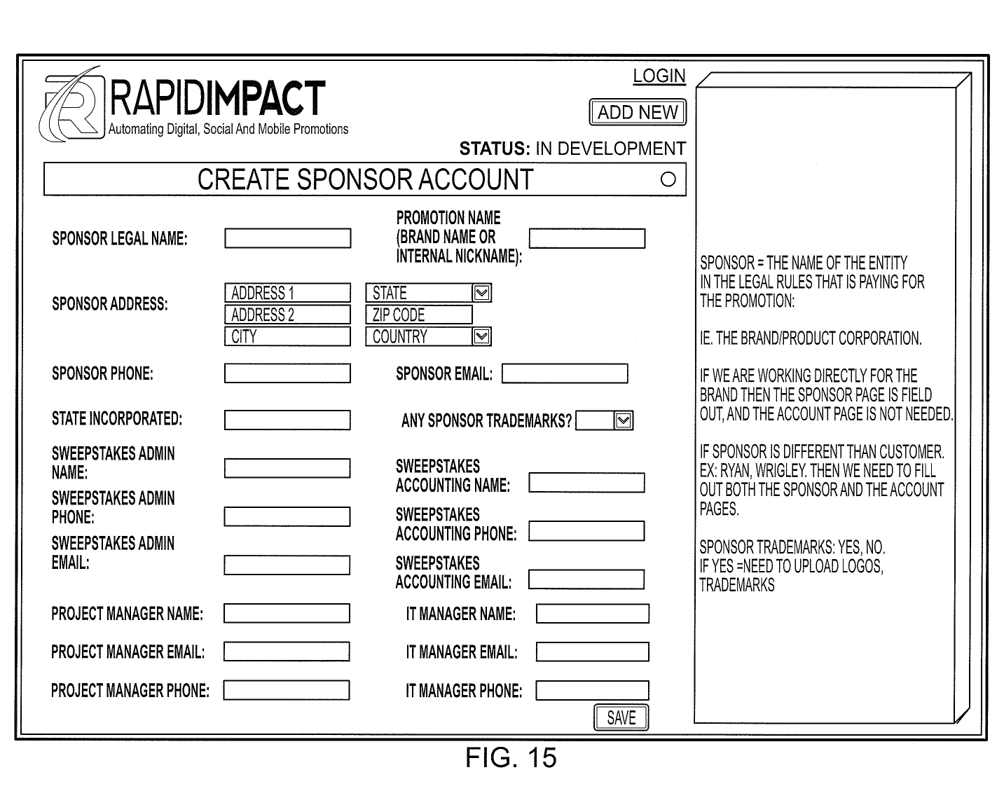

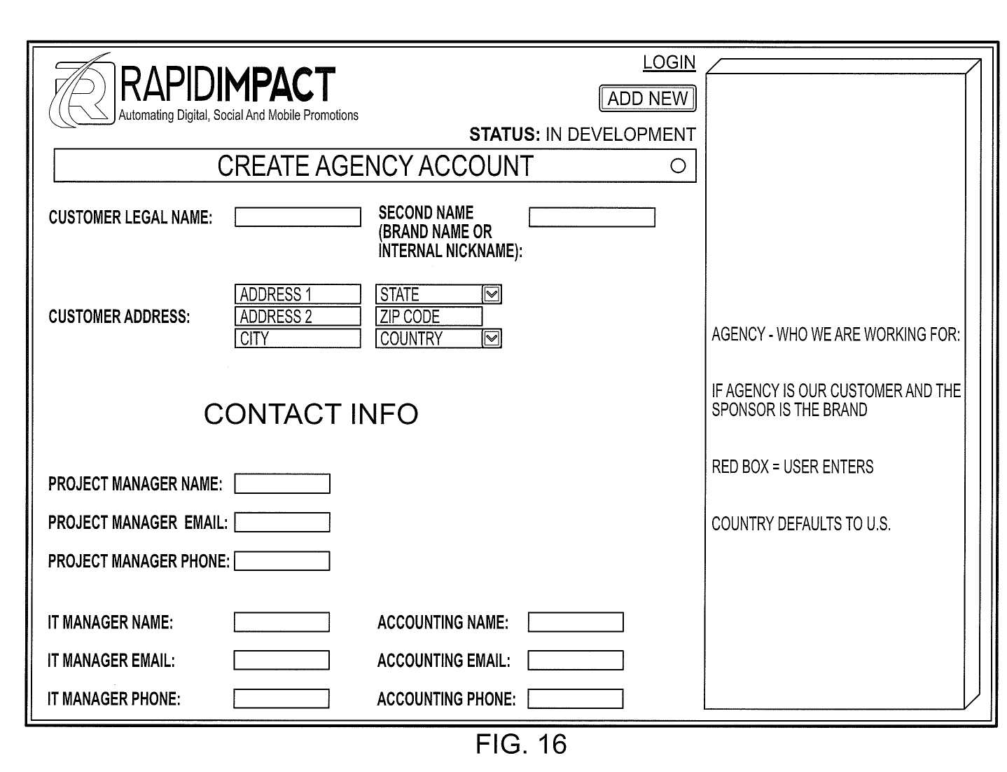

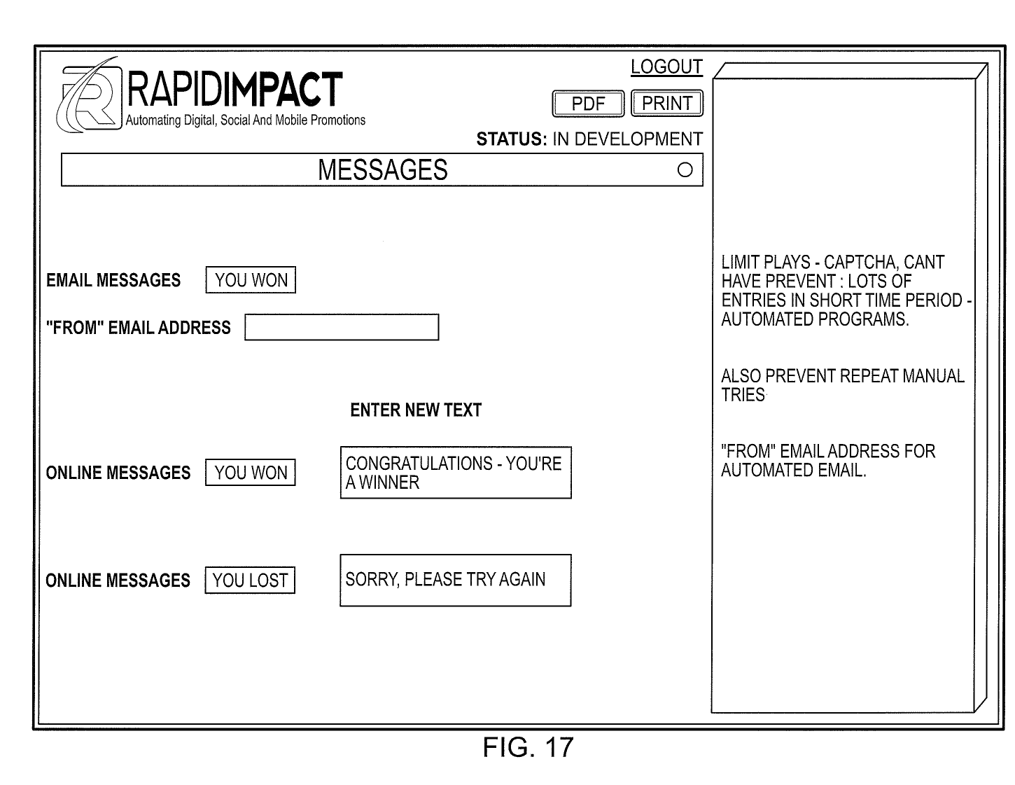

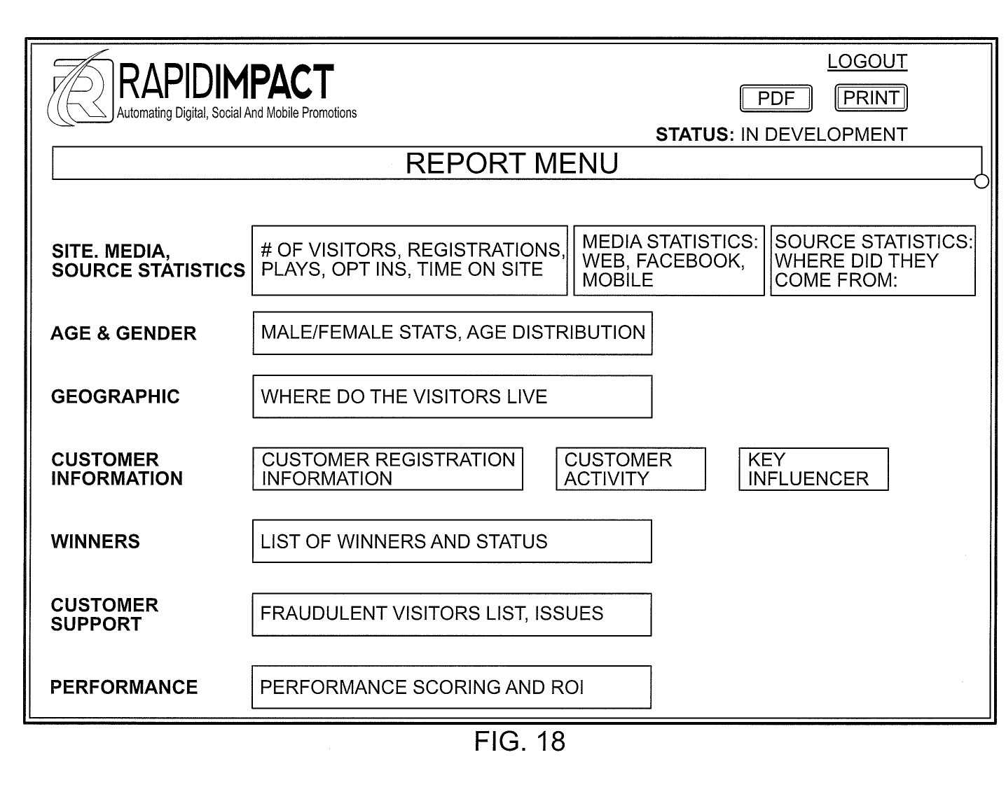

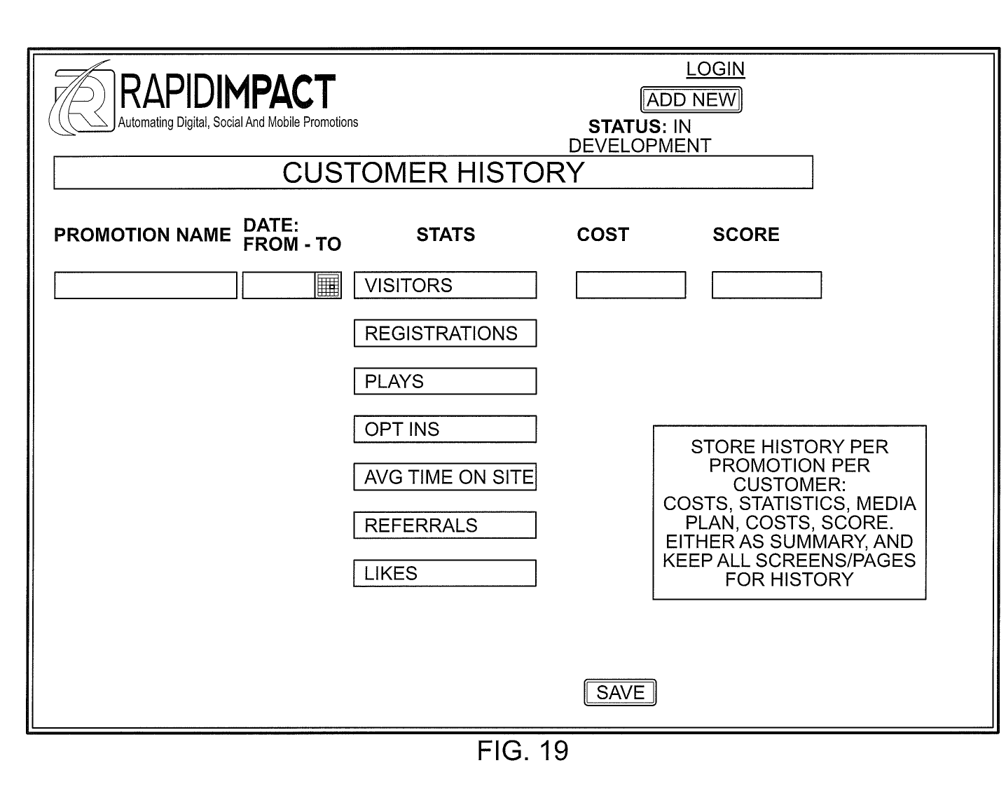

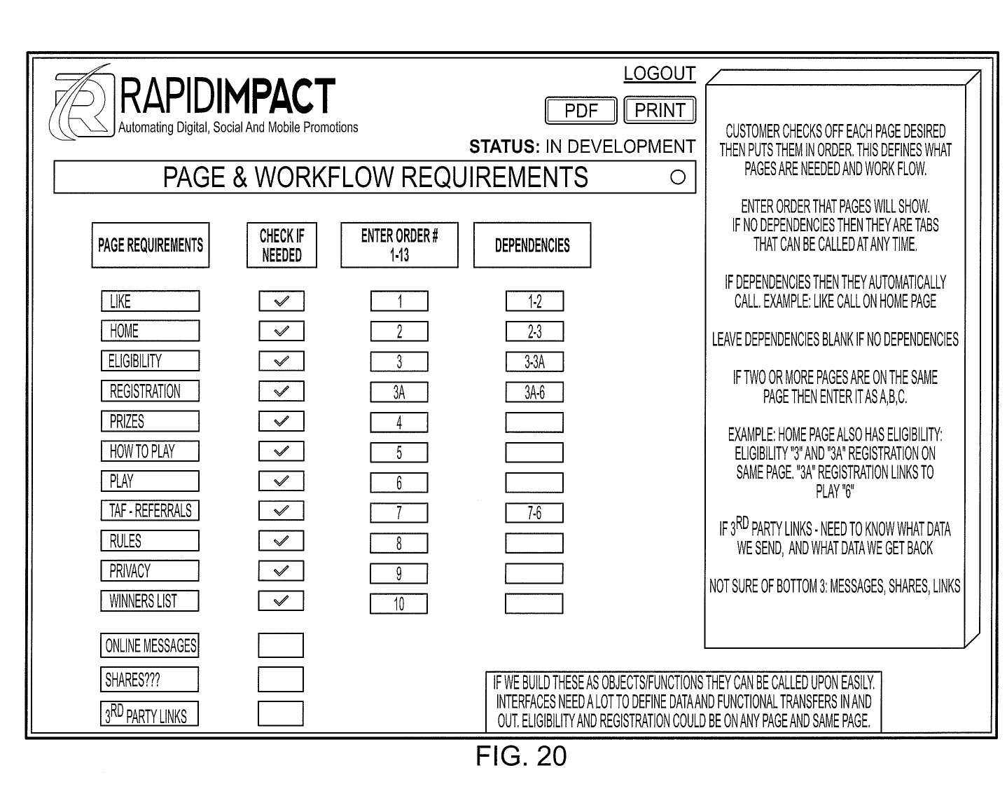

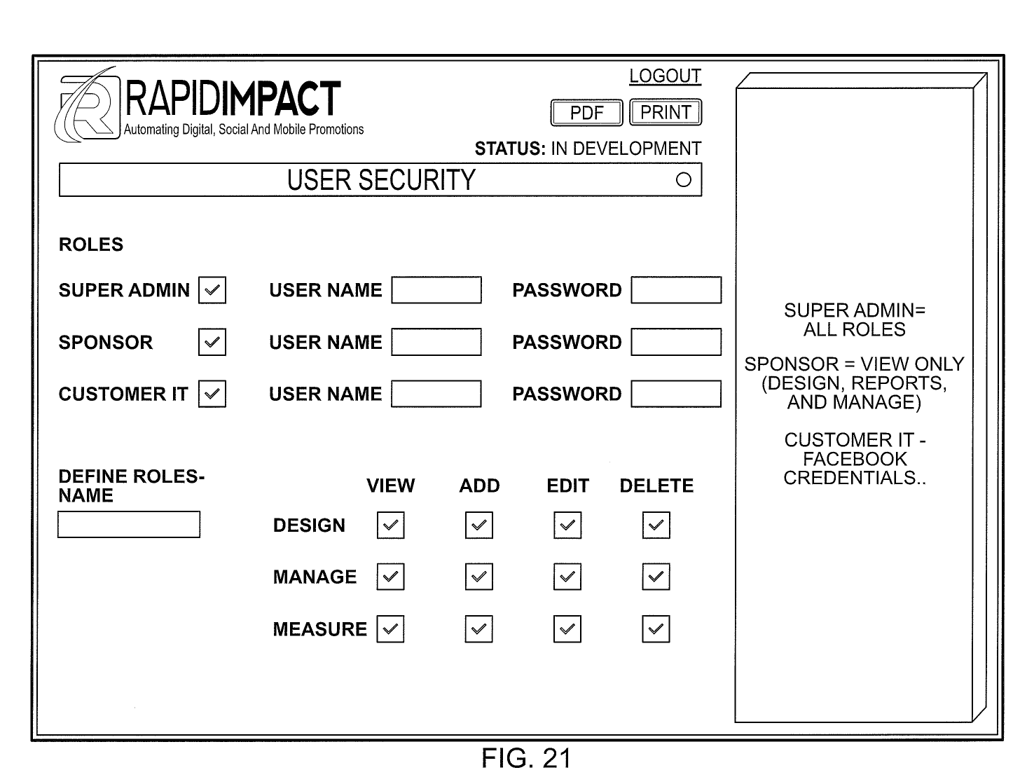

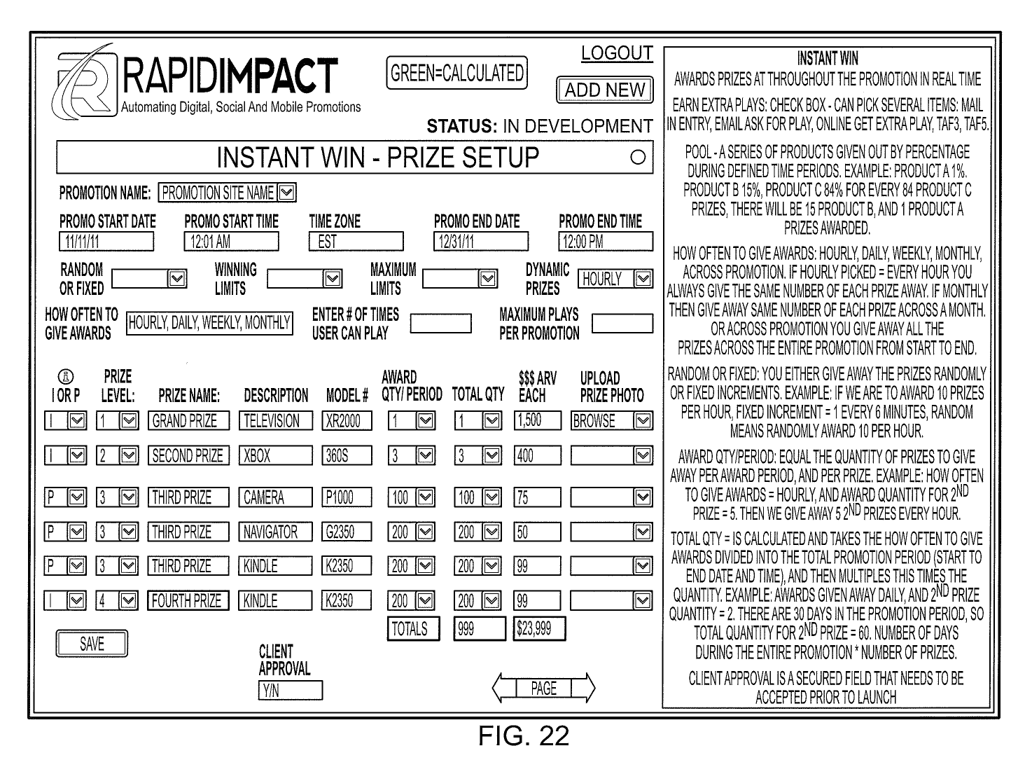

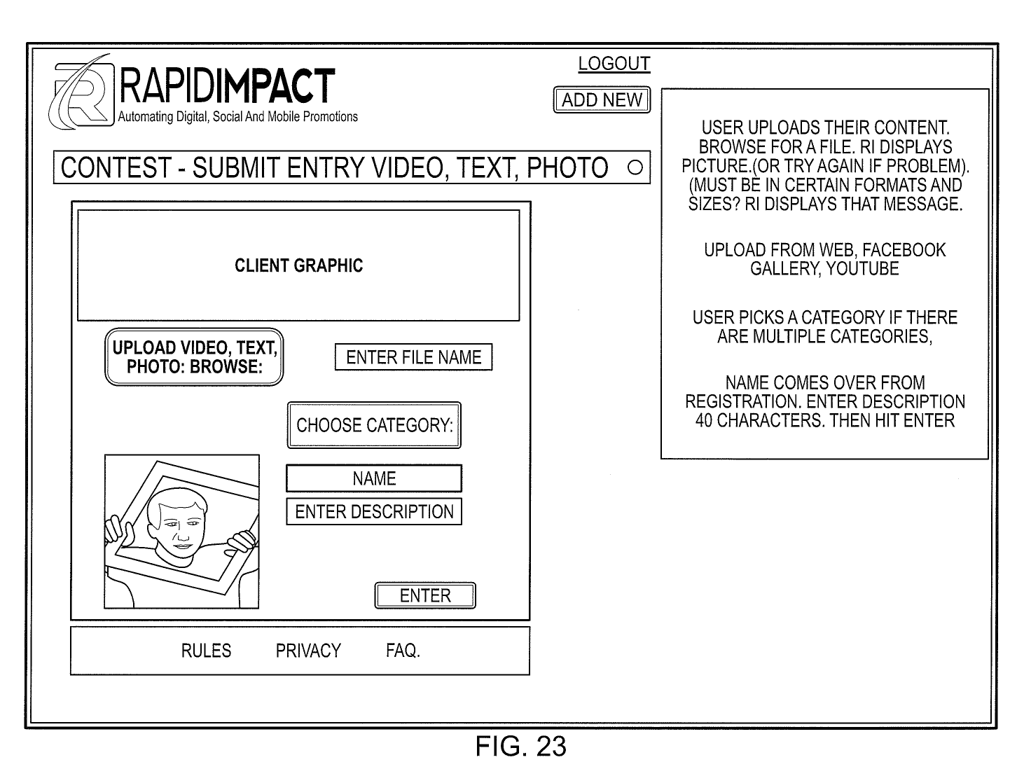

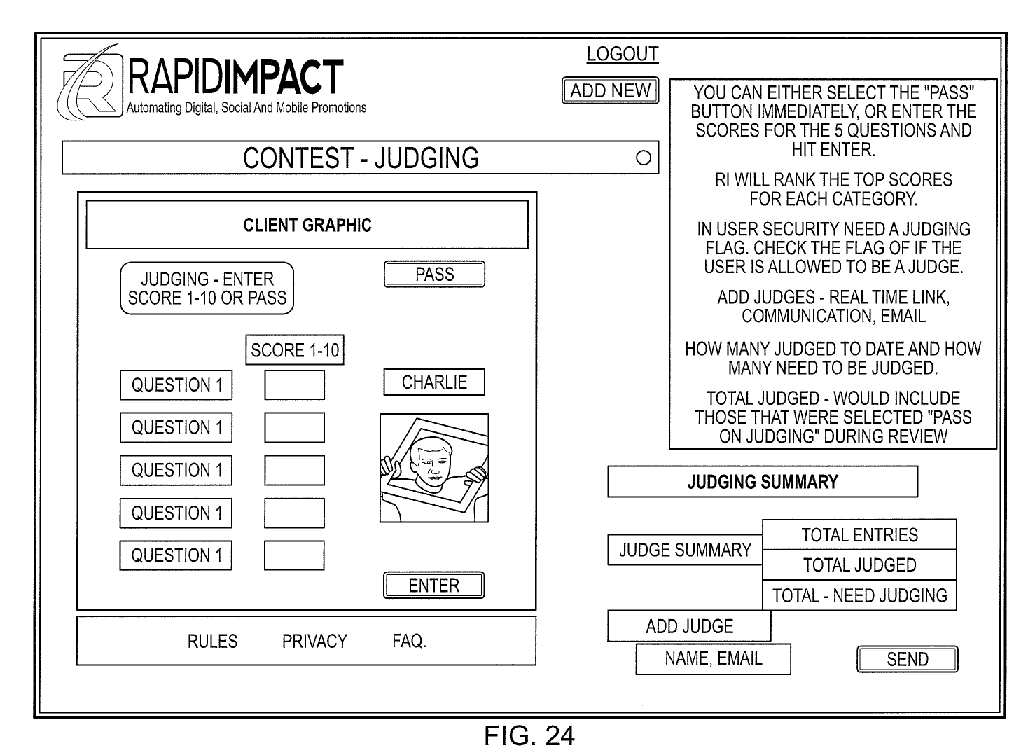

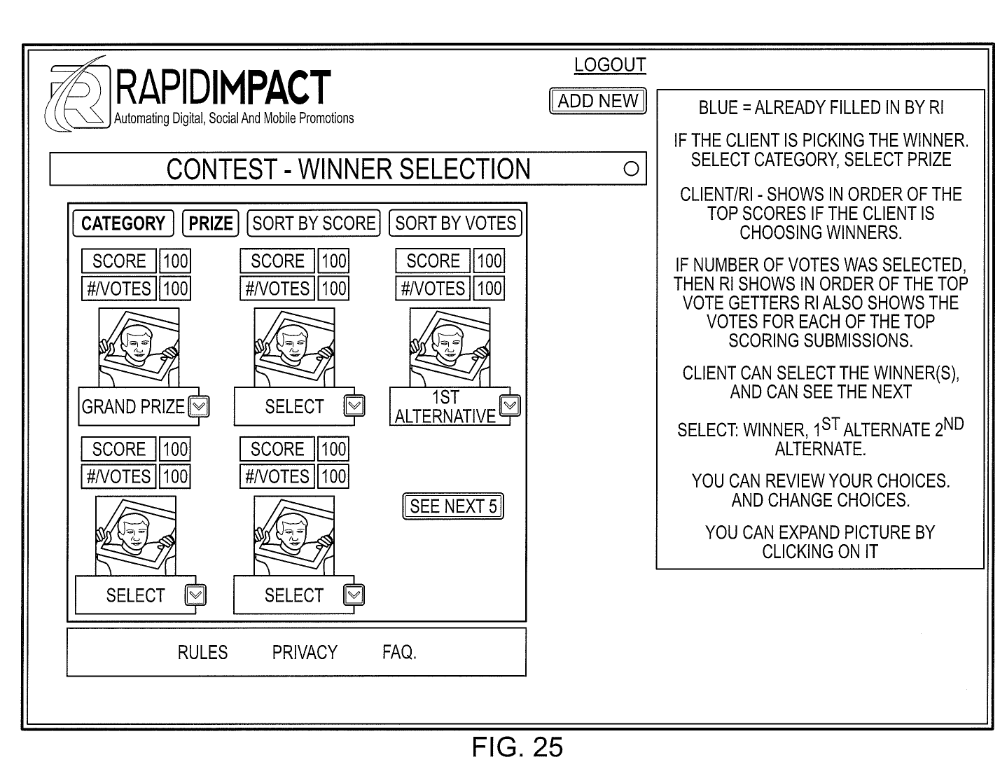

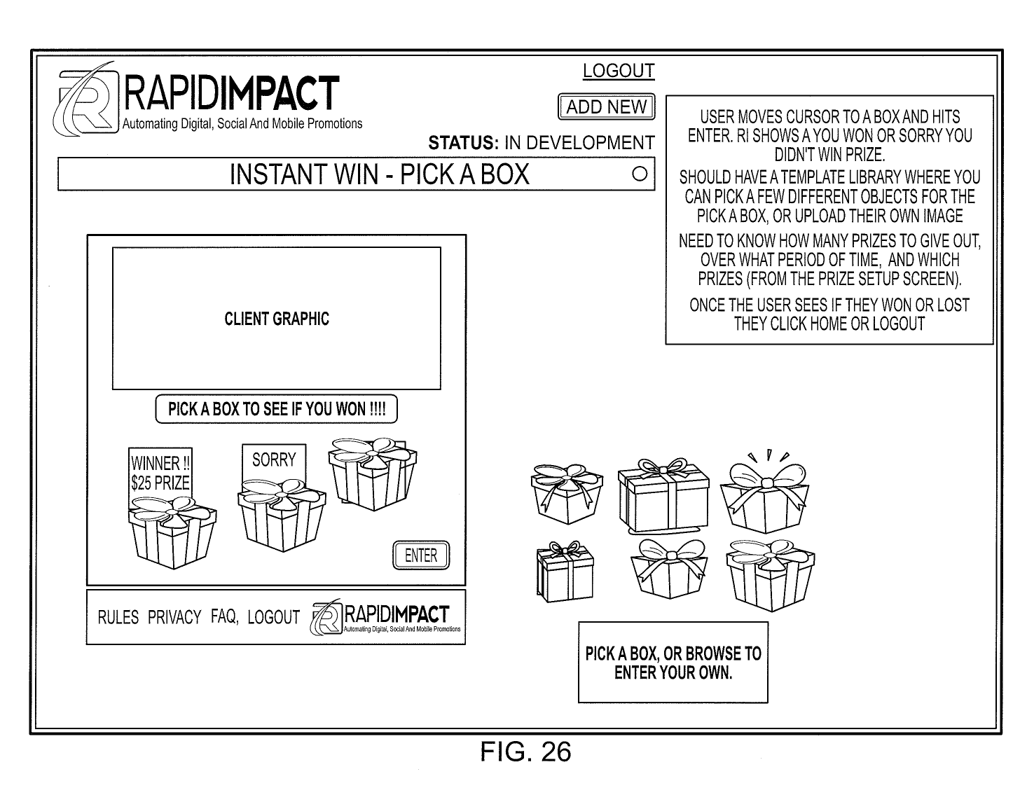

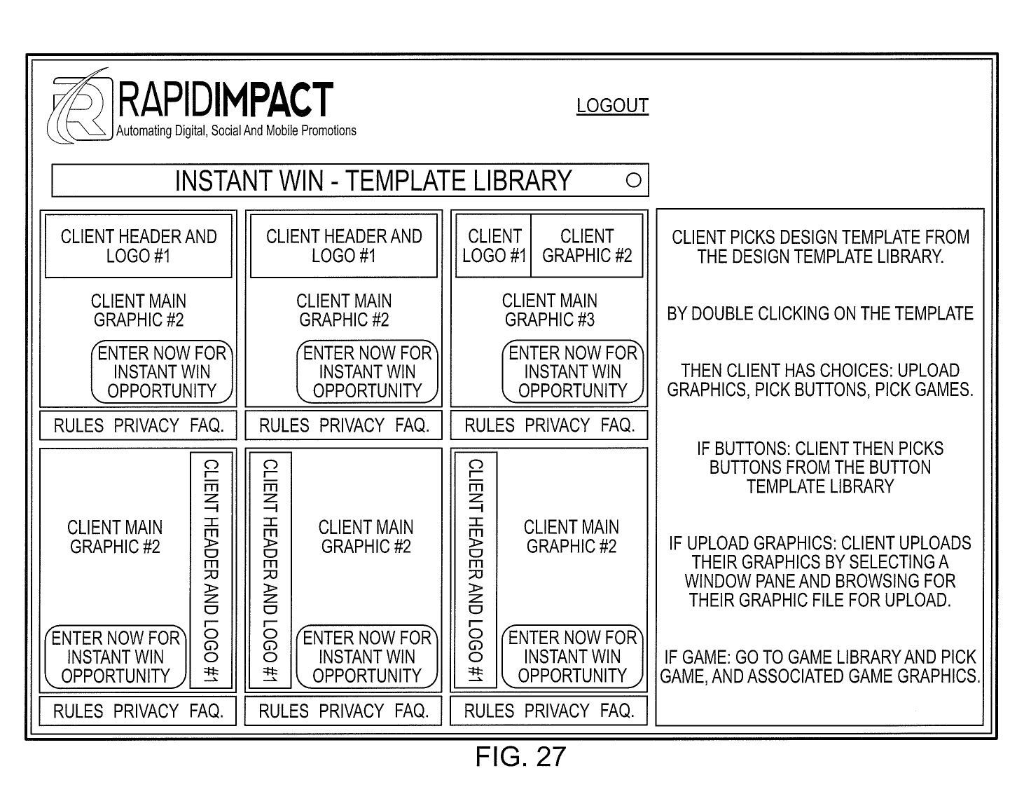

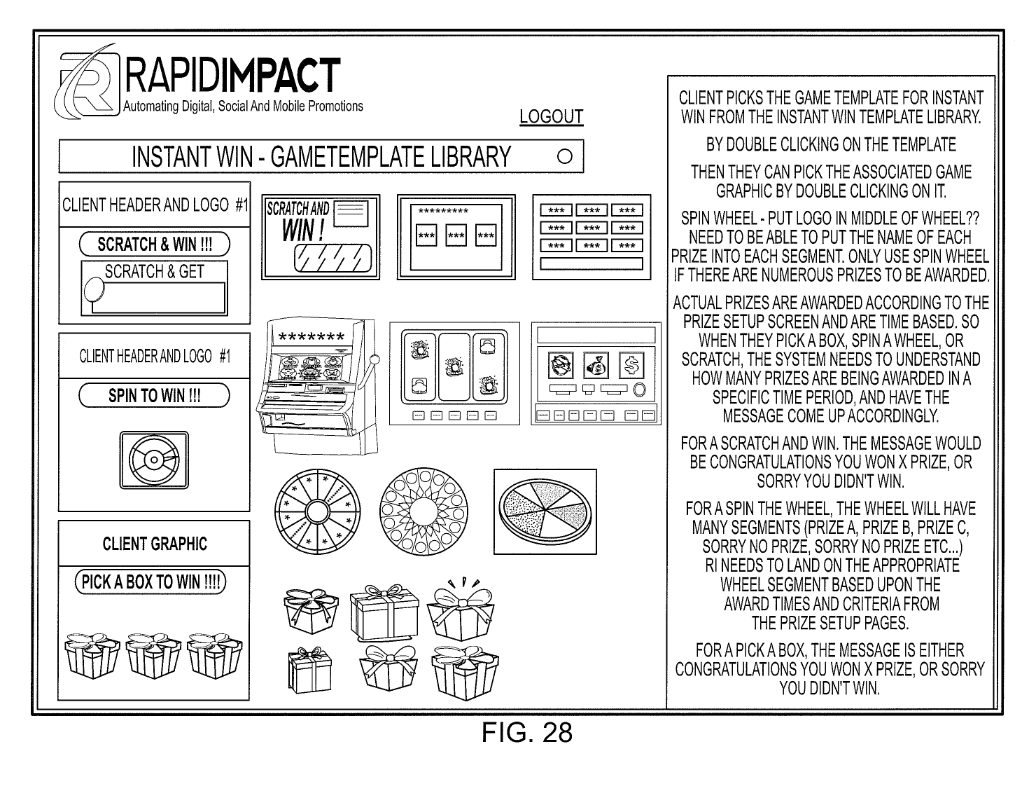

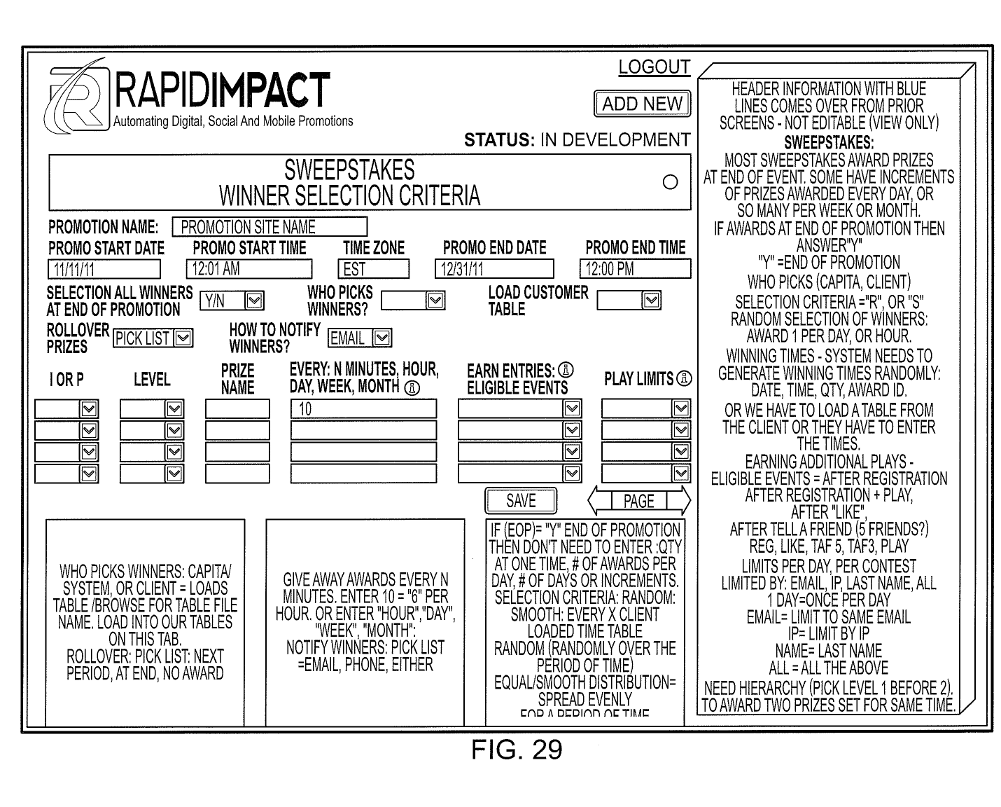

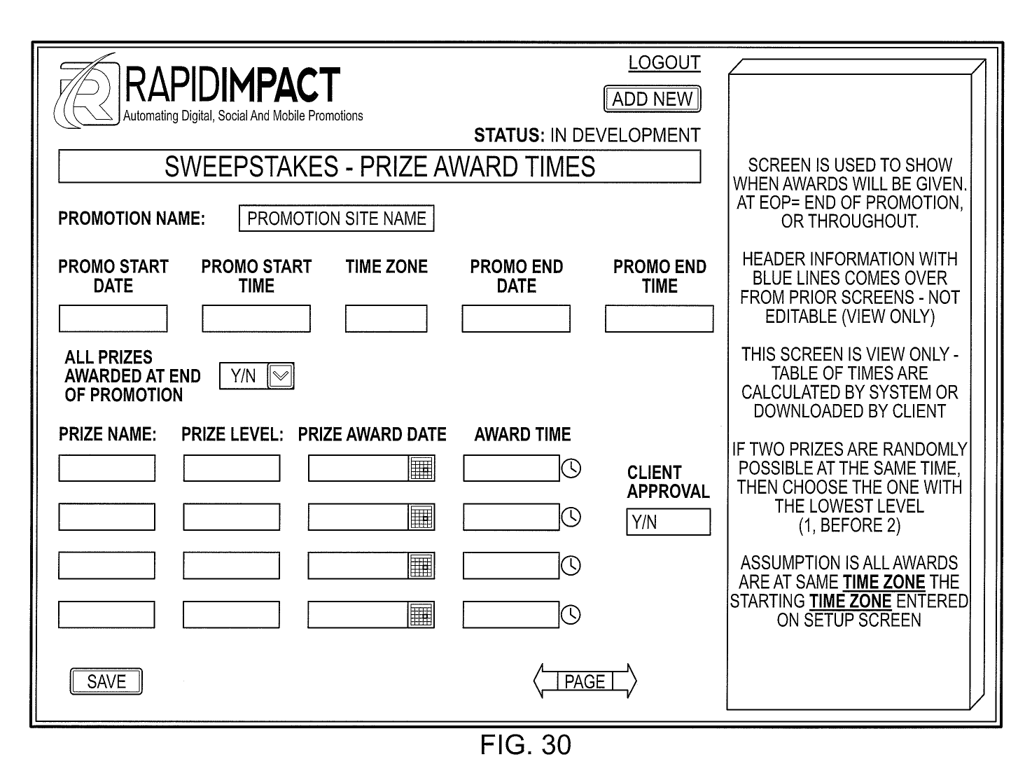

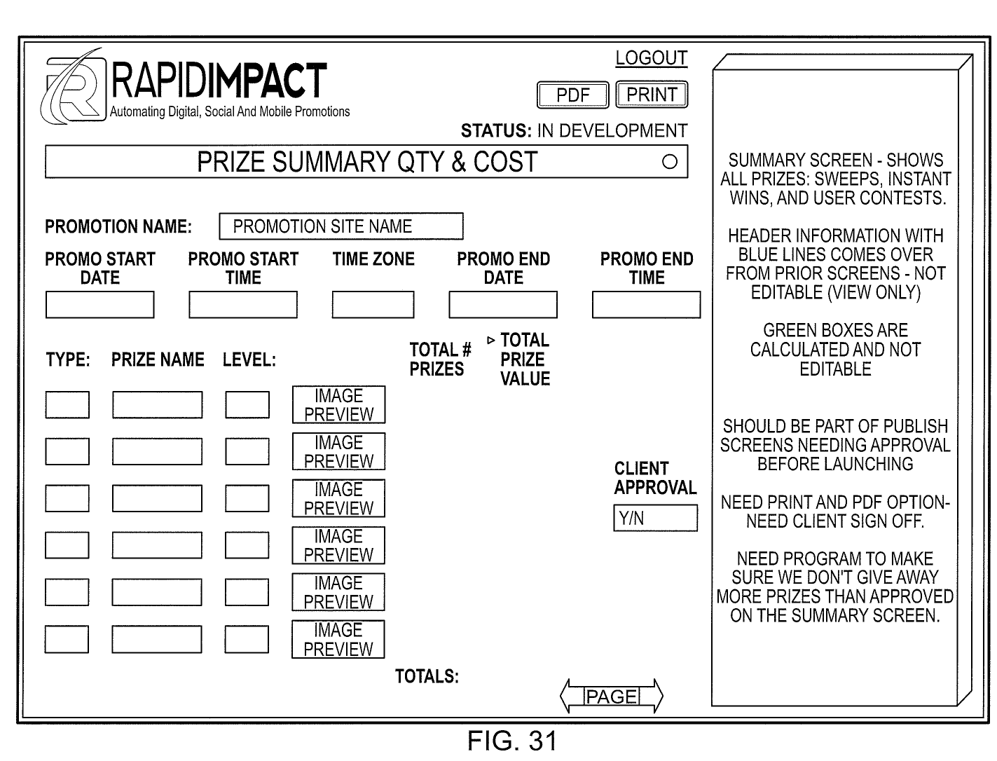

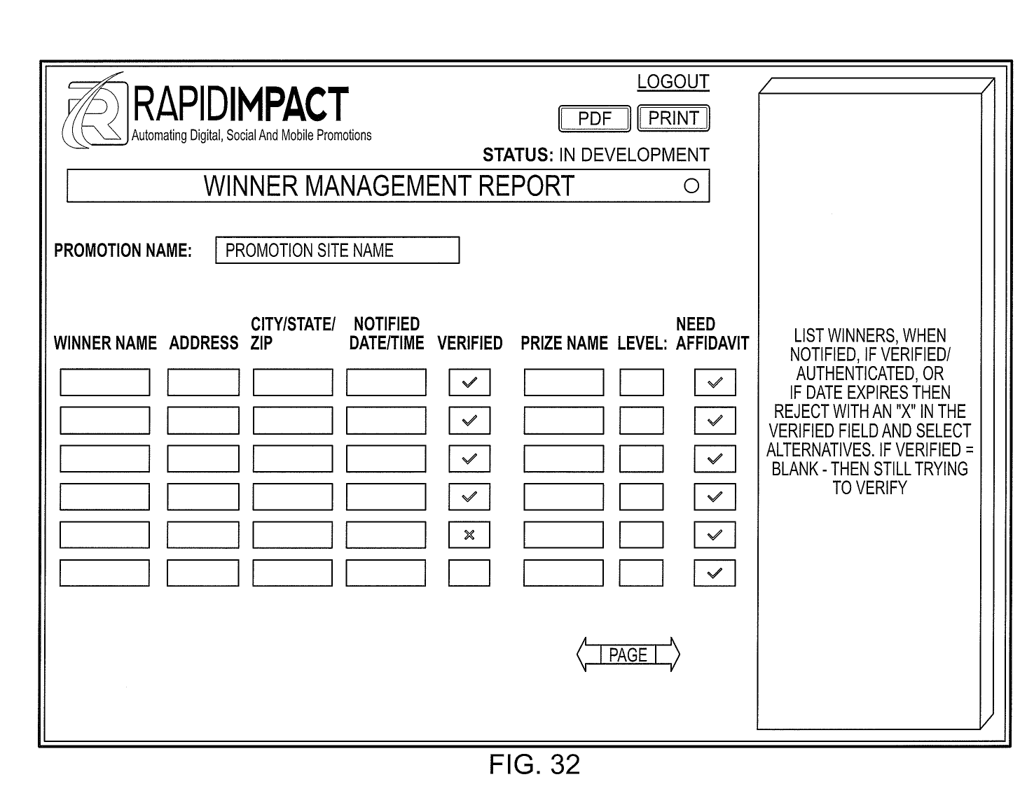

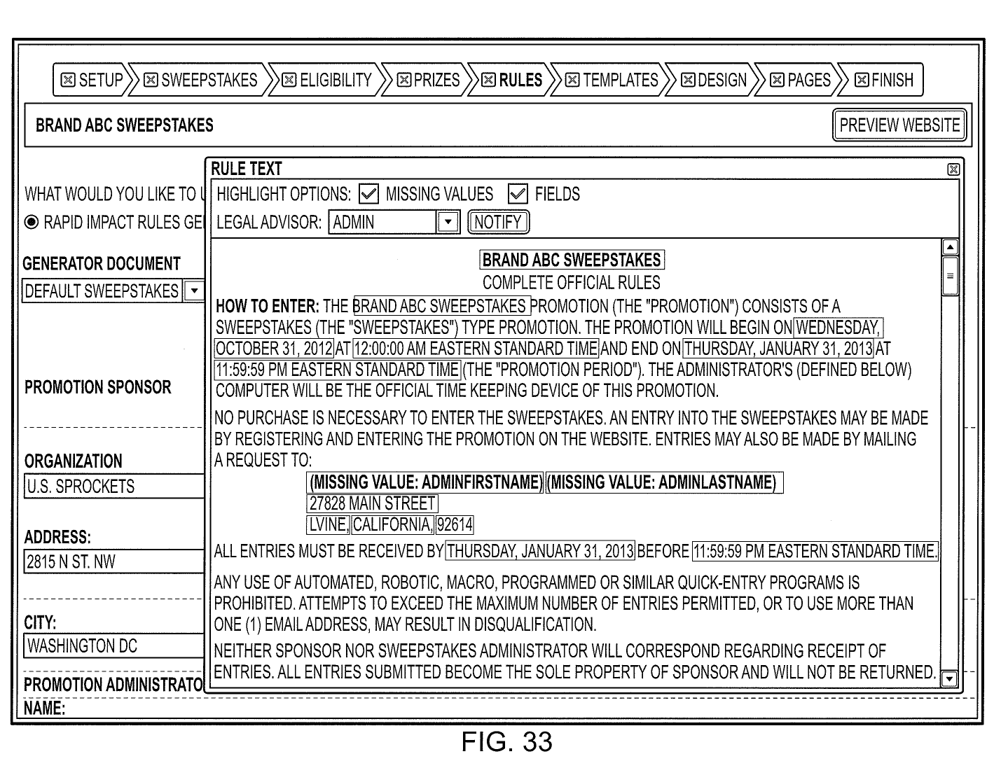

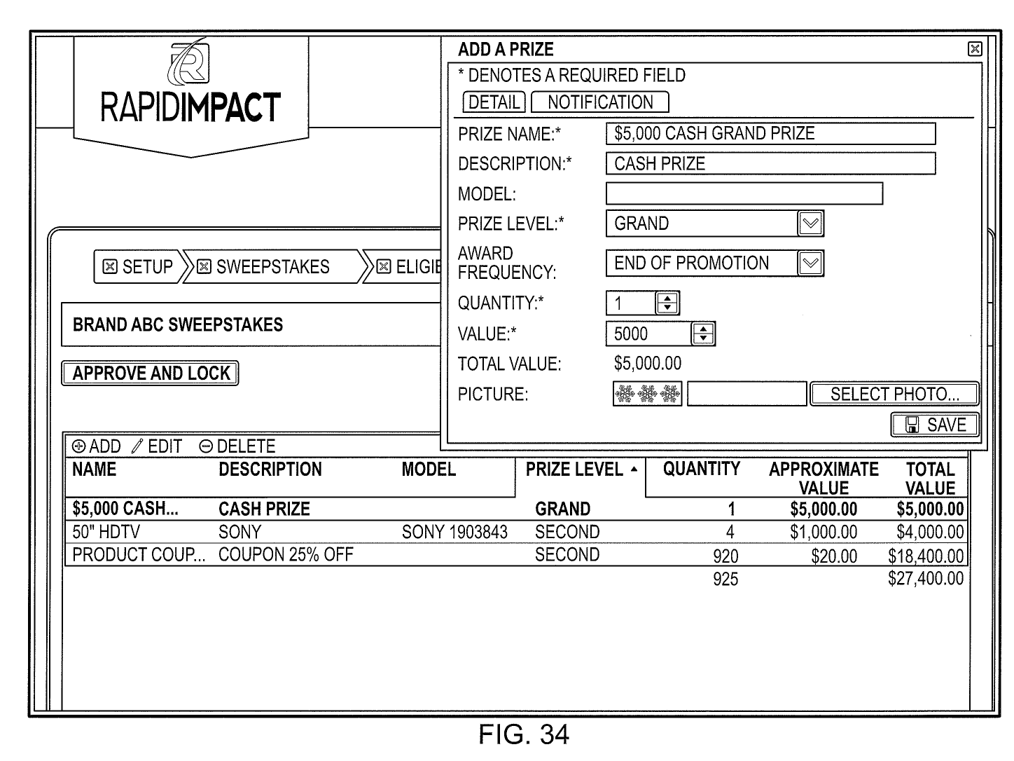

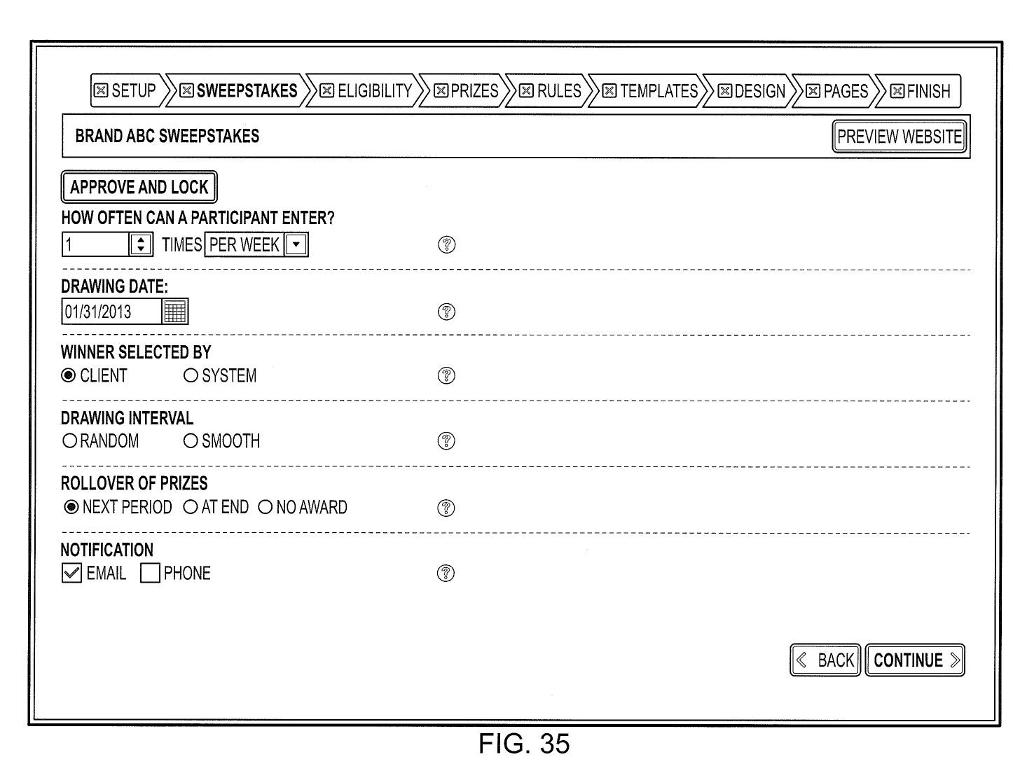

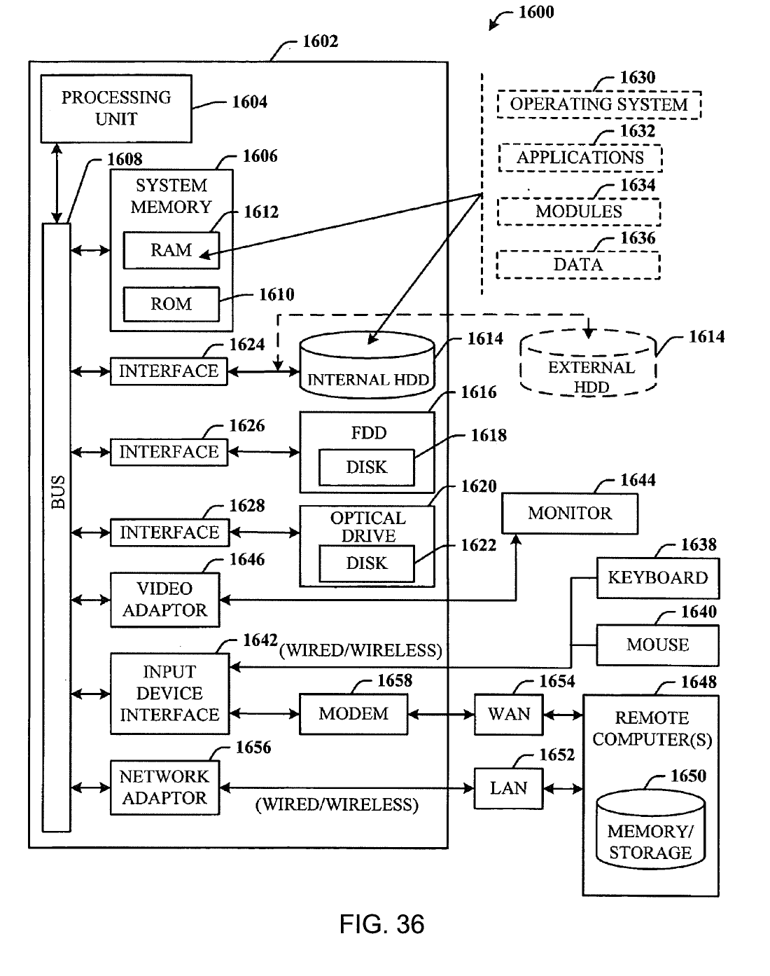

FIG. 7 depicts example screenshots illustrating aspects and example of generating, managing, managing, and/or distributing an example promotion;

FIG. 9 depicts example screenshots illustrating aspects and example of generating, managing, managing, and/or distributing an example promotion;

FIG. 10 depicts example screenshots illustrating aspects and example of generating, managing, managing, and/or distributing an example promotion;

FIG. 11 depicts example screenshots illustrating aspects and example of generating, managing, managing, and/or distributing an example promotion;

FIG. 12 depicts example screenshots illustrating aspects and example of generating, managing, managing, and/or distributing an example promotion;

FIG. 13 depicts example screenshots illustrating aspects and example of generating, managing, managing, and/or distributing an example promotion;

FIG. 14 depicts example screenshots illustrating aspects and example of generating, managing, managing, and/or distributing an example promotion;

FIG. 15 depicts example screenshots illustrating aspects and example of generating, managing, managing, and/or distributing an example promotion;

FIG. 16 depicts example screenshots illustrating aspects and example of generating, managing, managing, and/or distributing an example promotion;

FIG. 17 depicts example screenshots illustrating aspects and example of generating, managing, managing, and/or distributing an example promotion;

FIG. 18 depicts example screenshots illustrating aspects and example of generating, managing, managing, and/or distributing an example promotion;

FIG. 19 depicts example screenshots illustrating aspects and example of generating, managing, managing, and/or distributing an example promotion;

FIG. 20 depicts example screenshots illustrating aspects and example of generating, managing, managing, and/or distributing an example promotion;

FIG. 21 depicts example screenshots illustrating aspects and example of generating, managing, managing, and/or distributing an example promotion;

FIG. 22 depicts example screenshots illustrating aspects and example of generating, managing, managing, and/or distributing an example promotion;

FIG. 23 depicts example screenshots illustrating aspects and example of generating, managing, managing, and/or distributing an example promotion;

FIG. 24 depicts example screenshots illustrating aspects and example of generating, managing, managing, and/or distributing an example promotion;

FIG. 25 depicts example screenshots illustrating aspects and example of generating, managing, managing, and/or distributing an example promotion;

FIG. 26 depicts example screenshots illustrating aspects and example of generating, managing, managing, and/or distributing an example promotion;

FIG. 27 depicts example screenshots illustrating aspects and example of generating, managing, managing, and/or distributing an example promotion;

FIG. 28 depicts example screenshots illustrating aspects and example of generating, managing, managing, and/or distributing an example promotion;

FIG. 29 depicts example screenshots illustrating aspects and example of generating, managing, managing, and/or distributing an example promotion;

FIG. 30 depicts example screenshots illustrating aspects and example of generating, managing, managing, and/or distributing an example promotion;

FIG. 31 depicts example screenshots illustrating aspects and example of generating, managing, managing, and/or distributing an example promotion;

FIG. 32 depicts example screenshots illustrating aspects and example of generating, managing, managing, and/or distributing an example promotion;

FIG. 33 depicts example screenshots illustrating aspects and example of generating, managing, managing, and/or distributing an example promotion;

FIG. 34 depicts example screenshots illustrating aspects and example of generating, managing, managing, and/or distributing an example promotion;

FIG. 35 depicts example screenshots illustrating aspects and example of generating, managing, managing, and/or distributing an example promotion; and

FIG. 36 is a diagram depicting some example computing environments for systems for use in some aspects and examples of generating, managing, managing, and/or distributing an example promotion, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

This disclosure is drawn to methods, systems, devices and/or apparatus related to generating, managing, distributing, administering, and/or analyzing marketing promotion campaigns. Specifically, the disclosed methods, systems, devices and/or apparatus relate generating, managing, distributing, administering, and/or analyzing a variety of marketing promotion campaigns (including sweepstakes, user-generated contests, instant win campaigns, coupons, group buying promotions, sales incentives, trivia games, loyalty programs, donation promotions, and the like) on the Internet, social networks, and/or mobile platforms. There are many types of promotions, which may be combined for use in a single marketing promotion campaign.

In some examples, this disclosure discloses systems for simultaneous multimedia promotion management, where the systems may manage multiple promotions, each user (regardless of which promotions they wish to participate in), and what each user is allowed to play, and which awards each user may win across multiple media (including Internet, social networks, and mobile platform) simultaneously.

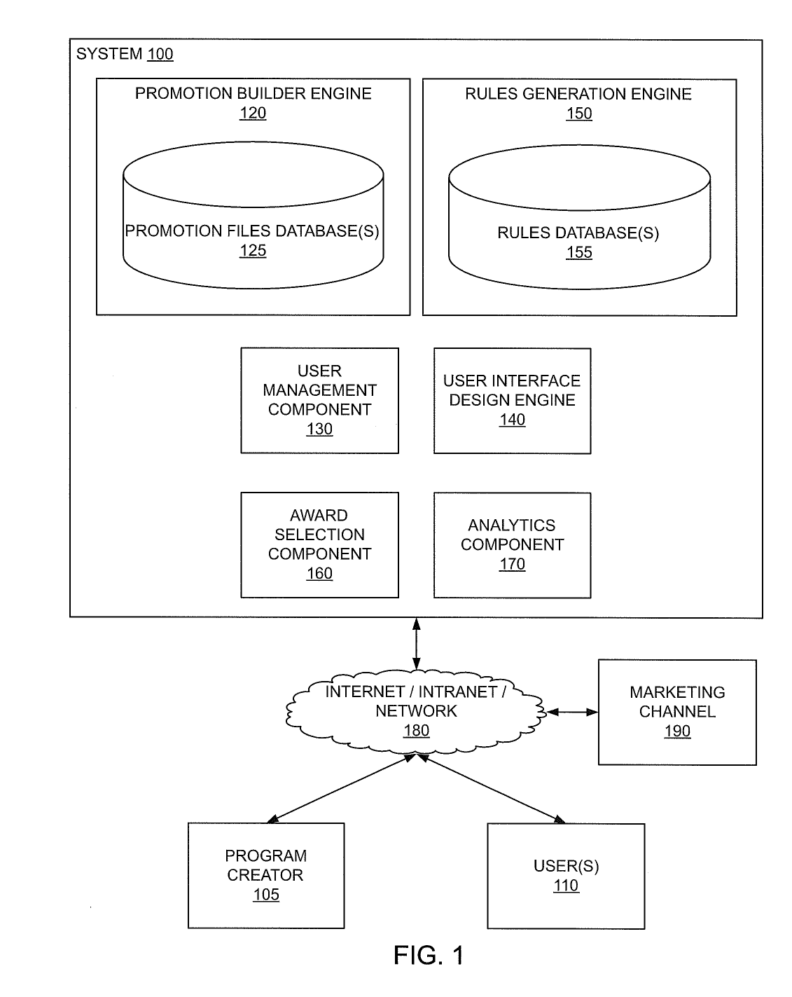

FIG. 1 depicts an example system 100 for generating a promotion. Example systems 100 may include a promotion builder engine 120, a user interface design engine 140, a user management component 130, a rules generation engine 150, an award selection component 160, and/or an analytics component 170. Promotion builder engine 150 may receive information associated with the promotion from a promotion creator 105, and structure the promotion based on the information associated with the promotion and promotion file database(s) 125 having predetermined promotion data. User interface design engine 140 may generate a user interface for the promotion. User management component 130 may manage users 110 of the promotion. Rules generation engine 150 may generate rules associated with the promotion. The rules may be based on the information association with the promotion and rules database(s) 155 having predetermined contractual language data. Award selection component 160 may manage awards(s) and/or select user(s) as winner(s) of an award. Analytics component 170 may analyze metrics of the promotion and may generate reports associated with the promotion.

In some examples, the system may include a distribution component distribute the promotion to a marketing channel 190. Example marketing channels 190 may include websites, microsites, social networks (e.g., Facebook®, LinkedIN®), computer networks, mobile platforms, digital signage, printed articles, printed documents). In some examples, distribution component may distribute the promotion to a social network or website using credential information (issued by the social network) allowing the promotion to appear on the social network or website.

In some examples, the system may include an award fulfillment component notify each winner of their respective award. Some example award fulfillment components may provide each winner with their respective award. This may occur via electronic transmission, physical delivery, and/or other means appropriate for the type of award.

As discussed above, in some examples, information associated with a promotion may be received by the system by a promotion creator 105. Example information may include the promotion type(s), award(s), start date and end date of the promotion, marketing channel(s) 190 in which the promotion will be distributed, eligibility conditions, prerequisites, security parameters (for fraud prevention), contact information of the promotion creator or other entities, promotion work flow, graphics, text, artwork, and/or animations, among others.

Further, in some examples, promotion builder engine 120 may structure the promotion based on the information associated with the promotion and promotion file database(s) 125 having predetermined promotion data. Example predetermined promotion data may include page template(s) for each respective promotion type, graphics, buttons, messages, libraries, registration fields, legal document templates, data associated with previously generated promotions (e.g., prior stored promotions), data associated with prior users (e.g., users that previously participated in a promotion), security rules for the promotion, and/or a blacklist of restricted users, among others. In some examples, the promotion builder engine 120 may structure the promotion on the information associated with the promotion and a previously generated promotion. For example, a promotion creator may utilize all or some aspects of a previously run promotion to generate a new promotion.

In some examples, user interface design engine 140 may allow promotion creator(s) 105 to customize the user interface of the promotion using a “skin,” background images, graphics, linkages, text, and/or templates, among other items.

In some examples, user management component 130 may manage users 110 in many aspects. Example aspects may include receiving user information associated with user(s) 110, creating an account for user(s) 110, registering user(s) 110 for the promotion, determining eligibility of user(s) 110 for participation in the promotion (based on eligibility requirements determined by the promotion creator, laws and/or regulations, among others), and authenticating user(s) 110 prior to their participation in the promotion.

In some examples, rules generation engine 150 may generate documents associated with the rules. For example, rules generation engine 150 may generate legal agreements associated with the promotion, terms and conditions of the promotion, entry forms for the promotion, and/or privacy policies associated with the promotion, among others. Example rules may relate to federal laws, federal regulations, state laws, state regulations, local laws, local regulations, purchase requirements for participation in the promotion, eligibility conditions for participation in the promotion, award details, award quantities, award values, instructions for participation in the promotion, limitations of the promotion, sponsor information, administrator information, and entry information (e.g., mail-in, fax, email, electronic entry).

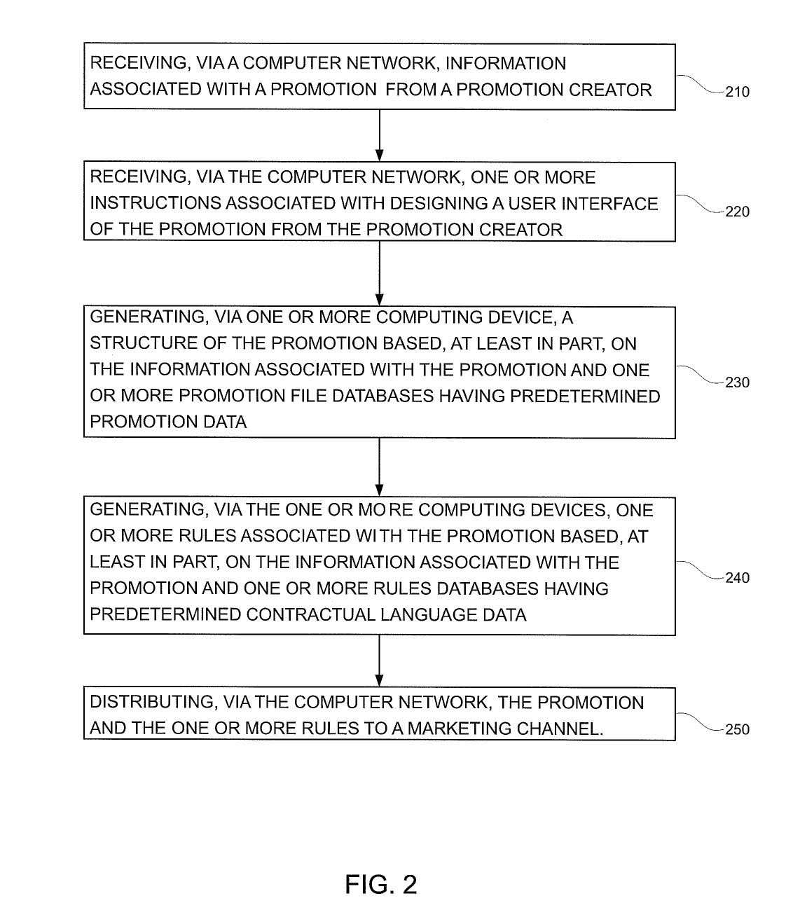

FIG. 2 depicts an example method 200 of generating a promotion. Example method 200 may include receiving 210, via a computer network, information associated with a promotion from a promotion creator. Example methods 200 may also include receiving 220, via the computer network, instructions associated with designing a user interface of the promotion from the promotion creator. Example methods 200 may further include generating 230, via a computing device, a structure of the promotion based on the information associated with the promotion and promotion file databases having predetermined promotion data. Example methods 200 may further include generating 240, via the computing device, rules associated with the promotion based on the information association with the promotion and rules databases having predetermined contractual language data. Example methods 200 may further include distributing 250, via the computer network, the promotion and the rules to a marketing channel.

Some example methods may also include registering, via the computer network, user(s) for the promotion. Some examples may include authenticating, via the computer network, user(s). Some examples may include providing access, via the marketing channel, to the promotion to authenticated user(s).

Some example methods may include selecting user(s) as winner(s) of an award. In some examples, the methods may include notifying winner(s) of their respective award(s) and/or providing winner(s) with their respective award(s). Some example methods may also include selecting one or more alternative winners.

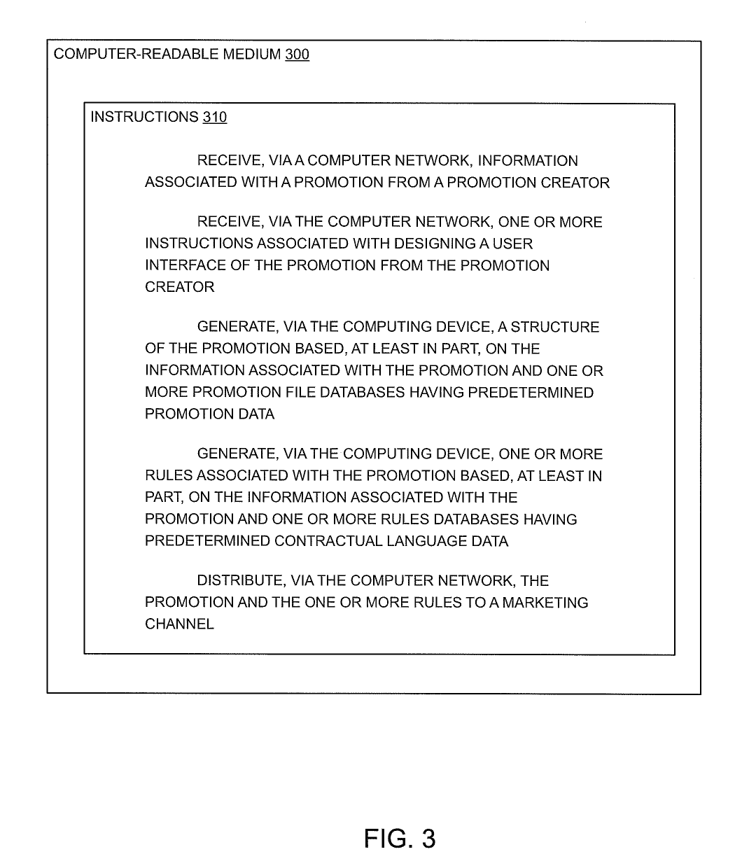

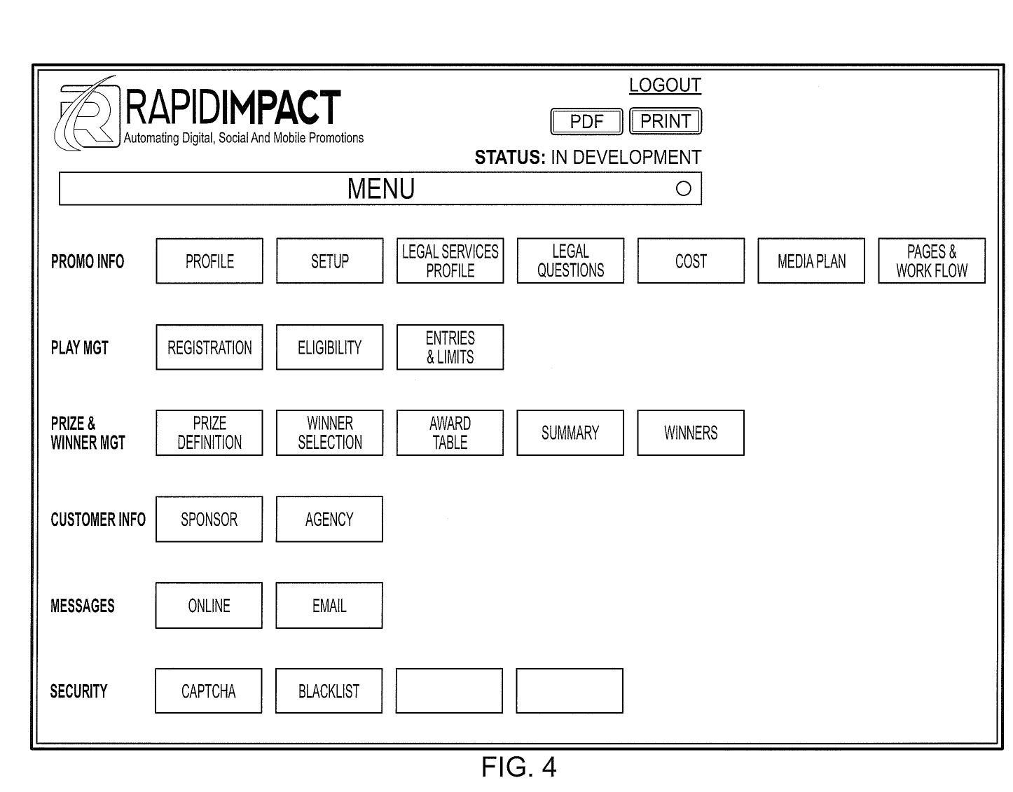

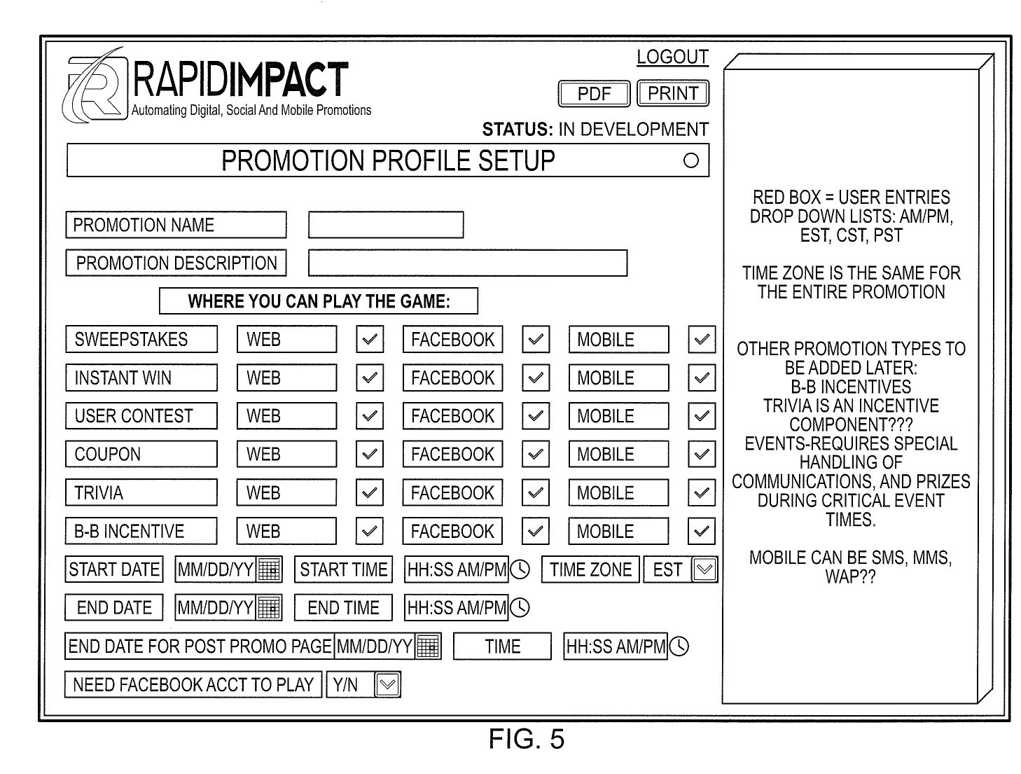

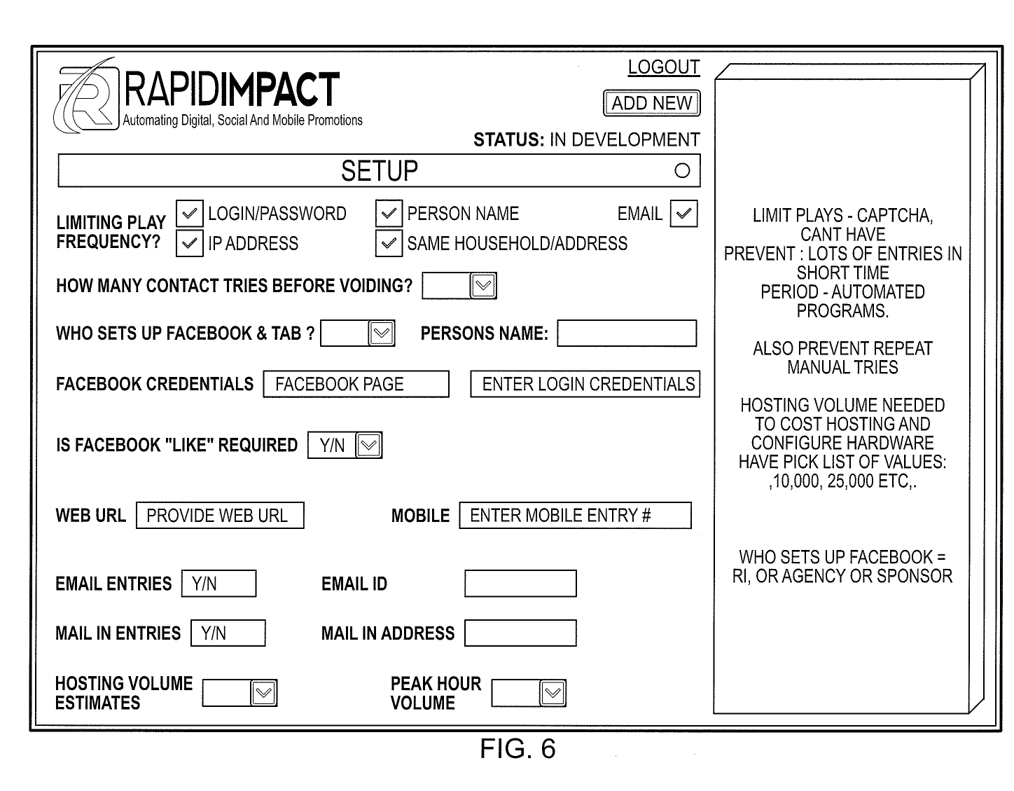

FIG. 3 depicts a computer-readable medium 300 having instructions 310 thereon, where the instructions 310 operate a network accessible computing device to perform certain operations associated with promotion generation. Example operations may include receiving, via a computer network, information associated with a promotion from a promotion creator. Example operations may also include receiving, via the computer network, instructions associated with designing a user interface of the promotion from the promotion creator. Example operations may further include generating, via the computing device, the structure of the promotion based on the information associated with the promotion and promotion file database(s) having predetermined promotion data. Example operations may also include generating, via the computing device, rules associated with the promotion based on the information associated with the promotion and rules database(s) having predetermined contractual language data. Further, example operations may include distributing, via the computer network, the promotion and the rules to a marketing channel. Rules may be varied by attorney, client, country, language (e.g., English, Spanish, Japanese), and/or other criteria.

In some examples, example operations may include generating, via the computing system, documents associated with the rules. Some example operations may include distributing, via the computer network, the promotion to a website, and/or allowing user(s) to access the promotion via the website.

Process, work flow, and other aspects of example systems and methods contemplated by the present disclosure will be described in more detail below.

Some example systems and methods provide the ability to create a promotion that simultaneously controls any combination of Internet, social network, and/or mobile platform promotions. The present disclosure contemplates that significant complexity arises from a large possible number of combinations of promotion types and media. Some example systems and methods manage each registered user, manage an award pool with a centralized award selection, and manage legal rules and business logic rules across multiple promotion types and media.

Promotion Builder Engine

Promotion creators may input promotion information and/or settings from an administrative dashboard (e.g., website), upload custom creative components such as artwork, and the promotion builder engine may create a promotion based on information provided by a user. The promotion engine builder may generate a promotion's structure based on information received about the promotion.

A general, example work flow of some aspects of the promotion builder engine is described in Table I.

TABLE I

| Example | |
|---|---|
| Promotion | |
| Category | Example Promotion Description |
| General | Select a promotion type (e.g., instant win, |
| | sweepstakes or user-generated contest) |
| | and enter promotion details. |
| Design | Select and/or customize a design skin, or |
| | upload custom creative content |
| Award | Pick giveaways from an award pool or |
| | identify and/or upload a custom award and |
| | select giveaway settings. |
| Codes | Generate or upload prize codes for instant |
| | win promotions. |
| Pages | Manage web content and generate |
| | registration forms. Fields from forms may |
| | automatically upload to a dynamic |
| | database. |
| Animations | Select flash animations from a library or |
| | upload custom animation. |
| Messages | Customize email and/or SMS messages, |
| | such as “Registration Confirmation” or |
| | “Thanks for Playing.” Promotion creators |
| | may also create and send communications |
| | to users. |
| Phases | Set a timeline for a promotion. Promotion |
| | builder engine may automatically execute |
| | the promotion timeline according to |
| | specified dates. |
| Social Media | Launch a promotion on social network (e.g., |
| | Facebook ® and/or Facebook Connect ®). |
| Tags | Manage analytic tags and events. |
| Eligibility | Define which users are allowed to |
| | participate for the promotion (e.g., age/state |
| | requirements) |
| Security | Set fraud prevention and security levels. |

Promotion creators may, for example:
Choose from sweepstakes, instant win, user generated contests, and social media promotions;
Create and launch a promotion microsite or Facebook® promotion;
Non-technical promotion creators may manage web content, prizes, codes, eligibility, fraud prevention, security, tags, email messages and blasts;
Advertise a promotion with viral sharing tools;
Obtain graphical reporting and real-time analytics/performance metrics; and/or
Scale the promotion to accommodate large numbers of users

In some examples, the promotion builder engine may guide promotion creators through the process of collecting information to initiate and manage a promotion. The promotion builder engine may organize the information for easy review and modification, with automatic revision control and notification of changes throughout a promotion creator's organization.

Promotion creators may select work flows and requested pages associated with the promotion. Some examples may automatically create written specifications with categorized narratives describing each aspect of the promotion.

In some examples, the promotion builder engine may be integrated with other engines and/or components described in this disclosure. This may assist promotion creators reduce legal time, define hosting requirements, reduce development revisions and rework, by auto generating functional specifications and work flow, promotion back end (e.g., types, media, awards, winner selection, messages, CRM, security, reporting) software development.

In some examples, a checklist of managed activities and tasks (displayed to the promotion creator) may make the creation and management of promotions easier.

In some examples, when a promotion creator interacts with the promotion builder engine, the promotion builder engine may require account login information, or may assist the promotion creator in creating an account (i.e., username and password). The promotion builder engine may request account information, contacts information, user information, and/or sponsor information.

When the promotion creator's account is complete, the promotion builder engine may request user role information. Here, the promotion creator may establish roles and/or security for any persons that may be interacting with the promotion or promotion builder engine. A person's ability to view, create, modify, delete and/or otherwise access the promotion, promotion builder engine, or information associated therewith, is dependent on that person's authorization. In some examples, only people given access and/or permission by a promotion creator may access certain aspects of the promotion or promotion builder engine. Further, a promotion creator may give only certain rights to the promotion or promotion builder engine to some people, while giving other people additional or different access rights. In some examples, a person's account (i.e., username and password) may be requested and/or checked prior to being authorized to access to a promotion or promotion builder engine.

Example user roles may include Project Manager, System Admin/IT, Approvers, Legal, Marketing, and/or Design, as described in Table II.

TABLE II

| Example User | |
|---|---|
| Role | Example User Role Description |
| Program | The promotion builder engine may guide the Program |
| Manager | Manager through a process to easily collect promotion |
| | information, to be able to review it and modify it easily, |
| | and to re-use it for future promotions. The promotion |
| | builder engine may guide the Program Manager to |
| | answer all promotion information and manage it in an |
| | easy to access and review and distribute to an |
| | organization and/or partners. |
| | The Program Manager Can may centrally manage and |
| | store cost information, media plans, and after promotion |
| | stats and effectiveness. |
| | Changes by the Project Manager may be automatically |
| | sent to others in the organization. Example: The |
| | number of awards has increased. This change may |
| | need review by Legal and IT. |
| | The Program Manager may utilize the promotion builder |
| | engine for monitoring prize management and play |
| | management to help manage fulfillment and prize |
| | information, eligibility, and/or create email messages. |
| System | System Admin/IT may utilize the promotion builder |
| Admin/IT | engine for technical setup information, security settings, |
| | hosting requirements, and/or creating development |
| | specifications. |
| Marketing | Marketing may utilize the promotion builder engine for |
| | media plans, cost information, sales information, to |
| | determine hosting requirements, and/or performance |
| | effectiveness and scoring. Budgeting functions collect |
| | the major categories of costs and sub costs for analysis, |
| | The project manager can track significant events and |
| | tasks to be completed and the system can calculate |
| | critical dates needed for completion. |
| Approver | Approvers may utilize the promotion builder engine to |
| | approve and lock the content of the promotion. |
| Legal | Legal may utilize the promotion builder engine for |
| | collecting information used to automatically generate the |
| | legal rules. May create and/or edit |
| | promotion legal rules after inputting pertinent |
| | information. May maintain a library of their legal |
| | templates by lawyer, promotion type(s), country, |
| | language, and customer/brand. |
| Design | Design may utilize the promotion builder engine for |
| | choosing interface, pages, design workflow, and basic |
| | layout of promotion, and/or manage, reuse assets, |
| | and HTML coding. |

While the present disclosure generally uses the term “promotion creator” in some examples, it should be understood that a promotion creator may include one or more user roles associated with the promotion creator. For example, in some examples, a Program Manager may perform the operations of a promotion creator.

The promotion builder engine may request information about the promotion. For example, the promotion builder engine may ask for type of promotions to be included in a campaign, on which media should each promotion be distributed, and promotion start dates and end dates, how many times a user may play per marketing channel, how many times a user may play per period of time period, how many times a user may win an award, can a user earn extra plays through sharing, how should award rollover be handled, among others. A promotion creator may also save prior promotion data to pre-fill sections of a new promotion automatically. Prior promotions may be retrieved by promotion name, brand, corporation, promotion type, and/or media type, for example.

In some examples, the promotion builder engine may include a copy function. If a promotion creator has generated prior promotions and wants to copy all or some of the information, the promotion creator may use the copy function. With this function, the promotion creator may search for the prior promotion, and may select all or individual content screens to be copied from the prior promotion into the new promotion. The promotion creator may also edit copied components. This may save promotion creators a lot of time if launching similar promotions.

The promotion builder engine may also request information regarding user eligibility, registration, ways a user may play, ways to earn extra entries or plays, and/or limits of how many times a user may play across multiple media channels.

The promotion builder engine may also request information regarding the awards, winner selection criteria, when winners will be selected, limits of what a user may win, what happens if there are no winners, and/or what happens if a winner fails to be valid/authenticated, by selecting alternative winners and notifying them.

The promotion builder engine may also request information regarding costs, media plans, and sales revenues associated with the promotion. This may assist in evaluating promotions metrics, effectiveness, and/or scoring, and may also assist in defining hosting requirements for the promotion.

The promotion builder engine may also request information regarding technical aspects of the promotion, including Uniform Resource Locators (URLs) for promotion distribution, credential information (if necessary), and/or tagging information.

The promotion builder engine may also request information regarding legal aspects of the promotion. This information may include information regarding bonding, registration, rules for entering and playing, eligibility, winner selection, winner notification, authentication, validation, affidavits, and/or additional information to generate legal rules.

In addition to promotion information provided by a program creator, some example promotion builder engines may utilize database(s) to generate promotions. An example database organization follows:

System Files & Libraries:
Page templates per promotion type, and for each functional page
Graphics, buttons, message Libraries
Registration fields
Legal templates: promotion type/paragraph/field
Database of prior promotions statistics/performance
Database of prior users
Security rules, blacklist

For each Client:
Account/User Security/organization structure
Promotion history, payment history

For each Promotion:
Promotion types and media picked.
Promotion Information: Profile, setup, IT info, Prize setup, Rules to play, winner selection criteria, limits, Registration, Eligibility, Security, Messages.
Promotion flags and settings
Forms/Pages/Templates, graphics, graphic and skin edits
User information
   Activity, Demographics, time on site, registrations/eligibility
Report Stats and Analytics
   Stats: visits, likes, plays, wins, losses, opt ins, shares/taf
Legal information
Performance scoring
Activity/event log files
Facebook ID/credentials, and Web URL
Final reviews, authorization, authentication
Winners list
Contests: submission library, categories, rounds of voting, reviews, judging, votes per submission/category, judge scores, winners & alternatives selected, notifications.

Instant Win: Code tables, award tables

User Interface Design Engine

In some examples, the user interface design engine may provide a program creator with capabilities to customize promotion user interfaces utilizing page template libraries, skin editing tools, test and graphic text editors, graphic libraries, and/or past promotion libraries, for example. Conventional products generally have only a couple of pages. In contrast, the user interface design engine may allow the program creator to have any number of design pages. Example pages may include social media “like” and/or “enter” pages, landing pages, registration and/or eligibility pages, award pages, privacy pages, rules pages, FAQ pages, “how to play” pages, “coming soon” pages, “promotion has ended” pages, winners list pages, contest gallery pages, and/or other similar pages.

Rules Generation Engine

The present disclosure contemplates that marketing promotions require detailed government (e.g., U.S. and worldwide) legal rules documents. Legal rules vary by promotion types, combinations, and other factors. Additionally, legal requirements affecting promotions vary across jurisdictions, such as from state to state, or nation to nation.

In some examples, the rules generation engine may use promotion information received by the promotion builder engine to generate legal rules (long form and/or short form) for the promotion. In some examples, the rules generation engine may create on-pack rules or on-card rules for use with printed articles and/or documents. The rules generation engine may acquire, maintain, and apply expert promotion legal knowledge, regulatory information, and marketing promotion experience, and legal expertise to auto generate the legal rules.

In some examples, a promotion creator may input answers to questions about a promotion, and the rules generation engine may generate legal documents (based on the inputted answers) for review, revision, approval, and/or distribution. In some example systems, a promotion creator may answer a long series of questions (e.g., 50-100 questions) detailing specific requirements of their promotion. After this information is completed and validated, the example system may utilize the rules generation engine to generate legal rules document(s). The rules generation engine may include acquiring and maintaining business rules, conditions, logic, and calculations about each country, promotion type, legal segment, and sentence structure and organization, for example. The rules generation engine may choose appropriate rules from rules database(s) having predetermined contractual language data, and may generate complete legal rules documents from this data and the inputted promotion data. In this manner, the promotion creator may review the legal document(s) and/or send it to their attorney and/or to appropriate regulatory organizations for review and approval. In some examples, the document(s) may be locked (i.e., no edits may be made within the document) and may be electronically distributed for regulatory purposes, electronically displayed with the live promotion, and/or ready for printing on marketing materials.

Each legal approver and their organization have their own library of legal rule templates. The legal rule templates can be stored by: Organization, Lawyer, Customer/Brand, Promotion Type, Promotion Name, Description, Country, and Language. The legal rule engine provides the legal approver with the ability to import their existing Intellectual Property into this library and either have the rules engine parse their document and automatically insert the appropriate promotion fields and promotion rules into their sentences/clauses, or let the approver select and insert the required promotion data fields and promotion rules into their documents.

An example legal rules document template is attached hereto, and incorporated herein, as Appendix I. An example legal rules document for an example promotion is attached hereto, and incorporated herein, as Appendix II. Also, FIG. 33 depicts an example legal rule.

Example rules generation engines may include legal and regulatory knowledge that is captured, categorized, and organized into a rules-based system.

When combined with the promotion information collected from the promotion builder engine, some example rules generation engines may create the entire promotion legal rules, generating each section of the legal rules one-by-one, such as rules relating to purchase requirements, liability clauses, eligibility (e.g., age, geography), award details, award quantities, award values, how to play, promotion limitations, sponsor information, administrator and sponsor information, and/or entry methods (e.g., mail-in entries), and others. In addition to generating the entire legal rules from scratch, generated legal rules may be stored, so they may be retrieved and copied in their entirety or portions thereof.

Legal and regulatory knowledge may be stored in a promotion ontology or categorization library, for use by the rules generations engine. Legal and regulatory knowledge may include knowledge of legal experts and regulatory requirements. Such information may be converted into business logic, calculations, business rules, and formulae and stored in rules database(s). In some examples, the legal rules may be organized by client, attorney, country, language, description, and/or promotion type.

A general, example work flow of some aspects of the rules generation engine are described below.

After receiving inputted promotion information, some example rules generation engines may capture and categorize the promotion information. The rules generation engine determines the legal rules hierarchy, structure, and/or organization. The rules generation engine may generate document(s) for each country, promotion type, and/or promotion segment. The rules generation engine may calculate and generate new data elements, determine sentences needed, and combine them with pre-defined electronic document templates. For each sentence, there may be one or more data elements that need to be inserted, determined, and/or calculated. The following is a simple example: “The promotion name is [X], and it starts on [Y day] and at [Z time].” The data elements for insertion are uniquely identified and correspond to data elements either collected from data input screens or calculated (Each Prize*Prize Value*Prize Quantity=Total Average Retail Value), and date calculations, or generated by the rules generation engine. This process may be repeated until the entire document(s) (long and/or short forms) are generated. Rules database(s) may include legal rule template libraries which may store pre-defined legal documents for certain promotion types, segments, and sentences with pre-defined areas for data insertion.

A program creator may select an existing legal template, and then manage the rules generation engine by adding, modifying, viewing and/or deleting rules, conditional logic, rule-based logic, business logic, calculations, and/or formulas. The program creator can manage the work flow for legal rule approval by selecting the lawyer for review and have them notified by email with a detailed message.

Some example systems may generate data elements from the promotion information (e.g., from 50-100 questions), and then with this data execute thousands of business rules. The possible permutations are very large to manage: N number of Countries*N number of Promotion Types (e.g., >10)*N number of Promotion type combinations (e.g., >9)*10-20 legal segments*sentences (e.g., 1-10). For example, a U.S. promotion with a sweepstakes, instant win, and user contest for Internet, social network, and mobile use, eligibility, sharing, country specific, and multilingual may have up to millions of rule permutations for the rules generation engine to process.

The rules generation engine may process each country, promotion type(s), combinations of promotion types, and segment by segment and sentence by sentence to determine which legal document templates to use, which sentences to construct and what data elements to insert or calculate into each sentence. For example, if the rules generation engine determines this a promotion includes a sweepstakes, it may retrieve a sweepstakes template, and starts with a first legal rule segment. A first legal rule segment may include “Is a purchase required?”, and the rules generation engine may review the inputted promotion information to see how the promotion creator answered this question (e.g., “yes” or “no”), and then may construct the sentence: “No purchases are required.”

After generation of the document(s), the rules generation engine may store the document(s) in the legal rule library for review, revision, approval, and/or re-use for future promotions. The document may be reviewed online and may show each piece of information automatically-inserted into the rules in a highlighted color. Missing fields that are required are highlighted in red. In some examples, missing fields may be highlighted in a different color, transmitted via email, and/or printed on a printer. The rules generation engine may insure the document(s) is initially approved by the promotion creator and locked to avoid any additional changes. The document(s) may be transmitted for legal review, and for final distribution with the promotion.

The promotion creator may review and/or revise the documents, and may regenerate the document by changing any of the promotion information. This review, revise, and regenerate process may continue until the promotion creator is ready, and then they can change the status of document from “under review” to “approved”, which means the document is ready for publication.

A promotion creator may utilize the rules generation engine independently of other engines and/or components of example systems. For example, if a promotion (not created with the systems disclosed herein) will be distributed and a program creator desires legal rules, the rules generation engine may be utilized as a standalone engine. The legal rule generator may notify a selected attorney for review and approval.

Award Selection Component

Some example systems may include an award selection component to provide an independent winner selection process. In some examples, a program creator may provide a list of users, and enter how many winners to select. The award selection component may provide the selected winners. In some examples, the list of users may be automatically obtained from a promotion instantiated by the promotion builder engine. In some examples, only a number of users and a number of winners to select are provided (e.g., 1,250 registrants and 2 winners), and numbers corresponding to the selected winners (e.g., user account numbers 98 and 691) are provided by the award selection component. In this manner, a promotion creator may identify the winners from user account records. In some examples, winner selection may include primary winners and back up winners (e.g., in case one or more primary winner is later deemed ineligible).

Analytics Component

Some example analytics components may provide real-time graphic reporting and/or performance evaluation benchmarks to measure the success of a promotion. Some example reports may include subject matter such as promotion metrics, consumer reports, website analytics, and/or prize and code reports. In some examples, program creators may view live promotion metrics and reporting. In some examples, there may be an online website (e.g., a dashboard) featuring live news feed, highlighting important activities such as awarded prizes, fraudulent activity threats, achieved goals, and the like. In some examples, program creators may instruct the news feed to display the most relevant information and updates.

Example analytics components may allow a program creator to:
Save data for comparison against other promotions, or against other promotions measured/scored by the example systems.
See which promotions are working and which promotions are not working. See sales effects, relative costs to performance, effect of media activities, what prize mix works the best, and the like.
See how a promotion performed relative to others with:
   Same promotions types: sweeps, instant win, contests, combinations
   Same media types: web, Facebook, mobile
   Relative same investment (within a dollar range)
   Similar award types
   Similar cost per registrations, visitors, opt ins, plays
Compare sales generated versus cost.
Compare sales lift % after promotion
Generate an overall score of 1-100

FIG. 36 illustrates an exemplary environment 1600 for implementing and/or controlling various aspects of an example system that includes a computer (or computing device) 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of an example system.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. It is appreciated that an example system can be implemented with various commercially available operating systems or combinations of operating systems.

A user can enter commands and information into the computer 1602 through one or more wired/wireless input devices, e.g., a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1602 is connected to the local network 1652 through a wired and/or wireless communication network interface or adapter 1656. The adaptor 1656 may facilitate wired or wireless communication to the LAN 1652, which may also include a wireless access point disposed thereon for communicating with the wireless adaptor 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wired or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for generating a promotion, the system comprising:
a promotion builder engine configured to receive substantial detailed information associated with a promotion from a promotion creator, and further configured to structure the promotion based, at least in part, on the information associated with the promotion and one or more promotion file databases having predetermined promotion data;
a user interface design engine configured to generate a user interface for the promotion;
a user management component configured to manage a plurality of users of the promotion;
a rules generation engine configured to generate the official promotion rules associated with the promotion, the one or more rules being based, at least in part, on the information association with the promotion and one or more rules databases having predetermined contractual language data;
an award selection component configured to manage a plurality of awards, and further configured to select one or more users from the plurality of users as a winner of at least one of the plurality of awards and notify them; and
an analytics component configured to analyze one or more metrics of the promotion and generate one or more reports associated with the promotion.

2. The system of claim 1, further comprising:
a distribution component configured to distribute the promotion to a marketing channel.

3. The system of claim 2, wherein the distribution component is configured to distribute the promotion to at least one or manage multiple channels simultaneously of a website, a microsite, a social network, a computer network, a mobile platform, digital signage, a printed article, and a printed document.

4. The system of claim 2,
wherein the distribution component is configured to distribute the promotion to a social network; and
wherein the information associated with the promotion includes credential information to allow the promotion to appear on the social network.

5. The system of claim 1, further comprising:
an award fulfillment component configured to notify each winner of their respective award, and further configured to provide each winner with their respective award.

6. The system of claim 1, wherein the information associated with a promotion includes at least one of a promotion type, an award, a start date of the promotion, an end date of the promotion, a marketing channel, an eligibility condition, a prerequisite, a security parameter, contact information, a work flow, graphics, text, artwork, and an animation.

7. The system of claim 6, wherein the promotion type comprises at least one or multiple combinations of a sweepstakes, a user-generated contest, an instant win campaign, a coupon, a group buying promotion, a sales incentive, a trivia game, a loyalty program, and a donation promotion.

8. The system of claim 7, wherein the predetermined promotion data comprises at least one of a page template for each respective promotion type, graphics, buttons, messages, libraries, registration fields, legal document templates, data associated with previously generated promotions, data associated with prior users, security rules, and a blacklist.

9. The system of claim 1, wherein the promotion builder engine is further configured to structure the promotion based, at least in part, on the information associated with the promotion and a previously generated promotion.

10. The system of claim 1, wherein the user interface design engine uses at least one of a skin, a background, a graphic, a linkage, text, and a template to generate the user interface.

11. The system of claim 1, wherein the user management component is configured to at least one of:
receive user information associated with at least one of the plurality of users;
create an account for at least one of the plurality of users;
register at least one of the plurality of users for the promotion;
determine eligibility of at least one of the plurality of users for participation in the promotion; and
authenticate at least one of the plurality of users prior to participation in the promotion.
Across multiple media channels and combinations of promotion types running simultaneously.

12. The system of claim 1, wherein the rules generation engine is further configured to generate one or more documents associated with the one or more rules.

13. The system of claim 12, wherein the one or more rules are associated with at least one of federal laws, federal regulations, state laws, state regulations, local laws, local regulations, purchase requirements, eligibility, award details, award quantities, award value, instructions for the promotion, limitations of the promotion, sponsor information, administrator information, and mail-in entry information.

14. A method of generating a promotion, the method comprising:
receiving, via a computer network, information associated with a promotion from a promotion creator;
receiving, via the computer network, one or more instructions associated with designing a user interface of the promotion from the promotion creator;
generating, via one or more computing device, a structure of the promotion based, at least in part, on the information associated with the promotion and one or more promotion file databases having predetermined promotion data;
generating, via the one or more computing devices, one or more rules associated with the promotion based, at least in part, on the information associated with the promotion and one or more rules databases having predetermined contractual language data; and
distributing, via the computer network, the promotion and the one or more rules to a marketing channel.

15. The method of claim 14, further comprising:
registering, via the computer network, a plurality of users for the promotion;
authenticating, via the computer network, at least one user of the plurality of users; and
providing access, via the marketing channel, to the promotion to each authenticated user.

16. The method of claim 14, further comprising:
selecting one or more users from a plurality of users as a winner of an award.

17. The method of claim 16, further comprising:
notifying each winner of their respective award; and
providing each winner with their respective award.

18. One or more computer-readable medium having instructions thereon, the instructions configured to operate a network accessible computing device to:
receive, via a computer network, information associated with a promotion from a promotion creator;
receive, via the computer network, one or more instructions associated with designing a user interface of the promotion from the promotion creator;
generate, via the computing device, a structure of the promotion based, at least in part, on the information associated with the promotion and one or more promotion file databases having predetermined promotion data;
generate, via the computing device, one or more rules associated with the promotion based, at least in part, on the information associated with the promotion and one or more rules databases having predetermined contractual language data; and
distribute, via the computer network, the promotion and the one or more rules to a marketing channel.

19. The one or more computer-readable mediums having instructions thereon of claim 18, the instructions further configured to operate a network accessible computing system to:
generate, via the computing system, one or more documents associated with the one or more rules.

20. The one or more computer-readable mediums having instructions thereon of claim 18, the instructions further configured to operate a network accessible computing system to:
distribute, via the computer network, the promotion to a website; and
allow at least one of a plurality of users to access the promotion via the website.
